(19) United States
(12) Patent Application Publication
(10) Pub. No.: US 2025/0007658 A1
(43) Pub. Date: Jan. 2, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jianfei CAO, Dongguan (CN); Zhe LIU, Dongguan (CN); Yun FANG, Dongguan (CN)

(21) Appl. No.: 18/883,822

(22) Filed: Sep. 12, 2024

Related U.S. Application Data
(63) Continuation of application No. PCT/CN2022/086559, filed on Apr. 13, 2022.

(51) Int. Cl. H04L 5/00; H04W 72/232

(52) U.S. Cl. CPC H04L 5/0035; H04L 5/0053; H04L 5/0096; H04W 72/232

(57) ABSTRACT

Embodiments of this application provide a wireless communication method, a terminal device, and a network device. The method includes: receiving first indication information sent by a first TRP of multiple transmission reception points TRPs, where the first indication information is used to indicate or update at least one unified transmission configuration indication TCI state. The first indication information sent by the first TRP of the multiple TRPs is introduced in this application, to indicate or update at least one unified TCI state to the terminal device.

### CROSS-REFERENCE TO RELATED APPLICATIONS

This application is a continuation of International Application No. PCT/CN2022/086559, filed on Apr. 13, 2022, the disclosure of which is hereby incorporated by reference in its entirety.

### TECHNICAL FIELD

Embodiments of this application relate to the field of communications, and more specifically, to a wireless communication method, a terminal device, and a network device.

### BACKGROUND

Currently, only downlink transmission configuration indication (TCI) states in release (Rel) 15/16 are applicable to downlink transmission of multiple transmission reception points (mTRP) in a new radio (NR) system. Specifically, a physical downlink control channel (PDCCH) and a physical downlink shared channel (PDSCH) use respective beam indication mechanisms. That is, the PDCCH uses a media access control (MAC) control element (CE) to activate one or two TCI states for a control resource set (CORESET) to which the PDCCH belongs, while the PDSCH may use downlink control information (DCI) to dynamically indicate a downlink beam. However, a TCI state indication mechanism related in Rel. 15/16 is applicable to only downlink channels and signals, and is subject to many limitations in application in the NR system, which affects and reduces system performance.

Therefore, for the downlink transmission of the mTRP, there is an urgent need in the art for a wireless communication method to improve system performance.

### SUMMARY

Embodiments of this application provide a wireless communication method, a terminal device, and a network device, which can improve system performance.

According to a first aspect, this application provides a wireless communication method. The method includes: receiving first indication information sent by a first TRP of multiple transmission reception points TRPs, where the first indication information is used to indicate or update at least one unified transmission configuration indication TCI state.

According to a second aspect, this application provides a wireless communication method. The method includes: sending first indication information to a terminal device, where the first indication information is used to indicate or update at least one unified transmission configuration indication TCI state.

According to a third aspect, this application provides a terminal device, configured to perform the method according to the first aspect or implementations of the first aspect. Specifically, the terminal device includes a functional module configured to perform the method according to the first aspect or implementations of the first aspect.

In an implementation, the terminal device may include a processing unit, where the processing unit is configured to execute a function related to information processing. For example, the processing unit is a processor.

In an implementation, the terminal device may include a sending unit and/or a receiving unit. The sending unit is configured to execute a function related to sending, and the receiving unit is configured to execute a function related to receiving. For example, the sending unit may be a transmitting set or a transmitter, and the receiving unit may be a receiving set or a receiver. For another example, the terminal device is a communication chip, the sending unit may be an input circuit or interface of the communication chip, and the sending unit may be an output circuit or interface of the communication chip.

According to a fourth aspect, this application provides a network device, configured to perform the method according to the second aspect or implementations of the second aspect. Specifically, the network device includes a functional module configured to perform the method according to the second aspect or implementations of the second aspect.

In an implementation, the network device may include a processing unit, where the processing unit is configured to execute a function related to information processing. For example, the processing unit is a processor.

In an implementation, the network device may include a sending unit and/or a receiving unit. The sending unit is configured to execute a function related to sending, and the receiving unit is configured to execute a function related to receiving. For example, the sending unit may be a transmitting set or a transmitter, and the receiving unit may be a receiving set or a receiver. For another example, the network device is a communication chip, the receiving unit may be an input circuit or interface of the communication chip, and the sending unit may be an output circuit or interface of the communication chip.

According to a fifth aspect, this application provides a terminal device, including a processor and a memory. The memory is configured to store a computer program, and the processor is configured to invoke and run the computer program stored in the memory, to perform the method according to the first aspect or implementations of the first aspect.

In an implementation, there are one or more processors, and there are one or more memories.

In an implementation, the memory may be integrated with the processor, or the memory is disposed separately from the processor.

In an implementation, the terminal device further includes a transmitting set (transmitter) and a receiving set (receiver).

According to a sixth aspect, this application provides a network device, including a processor and a memory. The memory is configured to store a computer program, and the processor is configured to invoke and run the computer program stored in the memory, to perform the method according to the second aspect or implementations of the second aspect.

In an implementation, there are one or more processors, and there are one or more memories.

In an implementation, the memory may be integrated with the processor, or the memory is disposed separately from the processor.

In an implementation, the network device further includes a transmitting set (transmitter) and a receiving set (receiver).

According to a seventh aspect, this application provides a chip, configured to implement the method according to any one of the first aspect and the second aspect or implementations of the first aspect or the second aspect. Specifically, the chip includes a processor, configured to invoke and run a computer program from a memory, to cause a device installed with the chip to perform the method according to any one of the first aspect and the second aspect or implementations of the first aspect or the second aspect.

According to an eighth aspect, this application provides a computer-readable storage medium, configured to store a computer program, where the computer program causes a computer to perform the method according to any one of the first aspect and the second aspect or implementations of the first aspect or the second aspect.

According to a ninth aspect, this application provides a computer program product, including computer program instructions, where the computer program instructions cause a computer to perform the method according to any one of the first aspect and the second aspect or implementations of the first aspect or the second aspect.

According to a tenth aspect, this application provides a computer program, and when the computer program is run on a computer, the computer performs the method according to any one of the first aspect and the second aspect or implementations of the first aspect or the second aspect.

Based on the foregoing technical solutions, the first indication information sent by the first TRP of the multiple TRPs is introduced in this application, to indicate or update at least one unified TCI state to the terminal device.

### BRIEF DESCRIPTION OF DRAWINGS

FIG. 1 is a schematic diagram of a 5G communication system according to an embodiment of this application.

FIG. 2 shows an example of an application scenario according to an embodiment of this application.

FIG. 3 is a schematic flowchart of a wireless communication method according to an embodiment of this application.

FIG. 4 shows an example of a transmission mode of mDCI-mPDSCH according to an embodiment of this application.

FIG. 5 shows an example of a MAC CE applicable to a transmission mode of mDCI-mPDSCH according to an embodiment of this application.

FIG. 6 shows an example of a transmission mode of sDCI-mPDSCH according to an embodiment of this application.

FIG. 7 shows an example of a MAC CE applicable to a transmission mode of sDCI-mPDSCH according to an embodiment of this application.

FIG. 8 is a schematic diagram of a timeline of a TCI state according to this application.

FIG. 9 is a schematic diagram of a timeline of a unified TCI state according to this application.

FIG. 10 shows an example of switching from multiple unified TCI states to a single unified TCI state by a terminal device according to an embodiment of this application.

FIG. 11 shows an example of switching from a single unified TCI state to multiple unified TCI states by a terminal device according to an embodiment of this application.

FIG. 12 shows an example of a MAC CE applicable to a transmission mode of SFN according to an embodiment of this application.

FIG. 13 to FIG. 15 show examples of a MAC CE carrying second indication information according to an embodiment of this application.

FIG. 16 is a schematic block diagram of a terminal device according to an embodiment of this application.

FIG. 17 is a schematic block diagram of a network device according to an embodiment of this application.

FIG. 18 is a schematic block diagram of a communication device according to an embodiment of this application.

FIG. 19 is a schematic block diagram of a chip according to an embodiment of this application.

### DESCRIPTION OF EMBODIMENTS

The following describes the technical solutions in embodiments of this application with reference to the accompanying drawings.

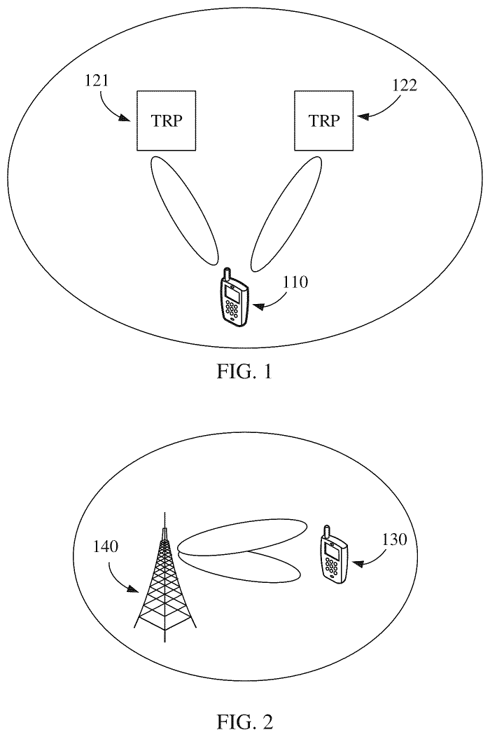

FIG. 1 is a schematic diagram of a 5G communication system 100 according to an embodiment of this application.

As shown in FIG. 1, the communication system 100 may include a terminal device 110, a transmission reception point (TRP) 121, and a TRP 122. The TRP 121 and the TRP 122 may communicate with the terminal device 110 through air interfaces, respectively. Specifically, the TRP 121 and the TRP 122 may independently schedule the terminal device 110 for data transmission. For example, the terminal device 110 detects, within one slot, PDCCHs from the TRP 121 and the TRP 122 respectively, used to schedule a plurality of independent uplink data transmissions, and the independent uplink data transmissions may be exactly scheduled to be in a same slot.

However, in the communication system shown in FIG. 1, there may be a plurality of communication scenarios.

For example, the TRP 121 and the TRP 122 belong to a same cell, and a connection (backhaul) between the TRP 121 and the TRP 122 is desirable, that is, information exchange may be performed fast and dynamically. For another example, the TRP 121 and the TRP 122 belong to a same cell, and a connection between the TRP 121 and the TRP 122 is not desirable, that is, information exchange between the TRP 121 and the TRP 122 cannot performed fast and only data exchange can be performed relatively slowly. For another example, the TRP 121 and the TRP 122 belong to different cells, and a connection between the TRP 121 and the TRP 122 is desirable. For another example, the TRP 121 and the TRP 122 belong to different cells, and a connection between the TRP 121 and the TRP 122 is not desirable.

In addition, different NR-PDCCHs/NR-PDSCHs may be sent from multiple TRPs to the terminal device 110, it means that the terminal device 110 can receive downlink information through multiple downlinks, where each downlink has corresponding uplink information to be transmitted. The uplink information includes at least one of the following signals: an acknowledgment/non-acknowledgment (ACK/NACK) corresponding to each downlink, report information including channel state information (CSI) corresponding to each downlink, and uplink data. It can be learned that if the terminal device 110 still needs to send uplink information on uplinks corresponding to a plurality of downlinks, it leads to high complexity and power consumption of the terminal device. In view of the foregoing problem, the TRP 121 or the TRP 122 may be used to indicate a transmission mode of uplink signals of the terminal device 110, so as to reduce complexity and high power consumption of the terminal device.

It should be understood that the 5G communication system 100 is merely used as an example for description in this embodiment of this application, but this embodiment of this application is not limited thereto. That is, the technical solutions in embodiments of this application may be applied to any communication system in which a plurality of network devices may independently schedule a terminal for data transmission. For example, a TRP in FIG. 1 is enabled to correspond to a beam, and in this case, an application scenario example shown in FIG. 2 may be obtained. The scenario includes a terminal device 130 and a network device 140, where there are a plurality of beams between the terminal device 130 and the network device 140.

The technical solutions in embodiments of this application may be applied to various communications systems, for example, a global system for mobile communications (GSM), a code division multiple access (CDMA) system, a wideband code division multiple access (WCDMA) system, a general packet radio service (GPRS), a long term evolution (LTE) system, an LTE time division duplex (TDD) system, and a universal mobile telecommunication system (UMTS).

This application describes various embodiments with reference to the network device and the terminal device.

The network device 130 may refer to any entity, used to send or receive signals, on a network side, and may be, for example, user equipment in machine type communication (MTC), a base transceiver station (BTS) in a GSM or CDMA, a NodeB in WCDMA, an evolved NodeB (Evolutional NodeB, eNB, or eNodeB) in LTE, or a base station device in a 5G network.

In addition, the terminal device 110 may be any terminal device. Specifically, the terminal device 110 may communicate with one or more core networks through a radio access network (RAN), and may also be referred to as an access terminal, user equipment (UE), a user unit, a user station, a mobile station, a mobile console, a remote station, a remote terminal, a mobile device, a user terminal, a terminal, a wireless communication device, a user agent, or a user apparatus. For example, the terminal device 110 may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal device in a 5G network, or the like.

For ease of understanding the solutions of this application, related content is described below.

### (1) Unified TCI State

In the progress of 3GPP standardization, the concept of TCI state was proposed in Release Rel. 15 for downlink spatial QCL (beam) indication and transmission of QCL information in time domain and frequency domain. Specifically, a quasi co-location (QCL) relationship may be simply described as a large-scale fading relationship from a source reference signal to a target reference signal. For beam indication, when UE obtains a QCL relationship between a source reference signal and a target reference signal from a network (NW), the UE can use a received beam of a previous source reference signal when receiving a target reference signal.

However, a TCI state indication mechanism is applicable only to downlink channels and signals, and is subject to many limitations in application in the NR system. Based on this, in order to provide a more unified uplink and downlink beam management mechanism for an NR system, 3GPP Rel. 17 proposed the concept of unified TCI state based on the design of TCI state in Rel. 15/16, to reduce beam indication frequency and resource consumption, thereby improving system performance.

For example, unified TCI states may include a joint TCI state, a separate DL TCI state, and a separate UL TCI state. The joint TCI state is applicable to uplink and downlink channels and signals. The separate DL TCI state is applicable only to downlink channels and signals. The separate UL TCI state is applicable only to uplink channels and signals.

For example, downlink channels (some PDCCHs or PDSCHs) and signals (aperiodic CSI-RSs) use a same downlink transmit indication beam, that is, the separate DL TCI state or the joint TCI state may be used; an uplink channel (PUCCH or PUSCH) and a signal (SRS) use a same uplink transmit beam, that is, the separate UL TCI state or the joint TCI state may be used.

For example, the unified TCI state may be dynamically updated and indicated by using a MAC CE and/or DCI.

For example, a unified TCI state may be applicable to a carrier aggregation scenario, and a beam indication on a single CC may be applicable to a plurality of different CCs.

For example, an uplink beam indication may be provided together with an uplink power control parameter through a separate UL TCI state or a joint TCI state.

For example, a unified TCI state may support an inter-cell beam management function.

For example, CORESETs on CCs may be roughly classified into the following four types:

CORESET A: It is associated only with a UE-specific search space, and therefore it may be considered as a UE-specific downlink control channel resource, and needs to follow an indicated unified TCI state.

CORESET B: It is associated only with a cell-common search space. Whether it may follow a unified TCI state indicated by an NW depends on an RRC configuration of the NW.

CORESET C: It is associated with both a UE-specific search space and a cell-common search space. Whether it can follow a unified TCI state indicated by an NW depends on an RRC configuration of the NW.

CORESET 0: It is definitely associated with a cell-common search space, and may also be associated with a UE-specific search space. Whether it can follow a unified TCI state indicated by an NW depends on an RRC configuration of the NW.

It should be understood that following an indicated unified TCI state in this application may be understood as being applicable to an indicated unified TCI state or having a similar meaning, and this is not specifically limited in this application.

(2) Transmission Scheme of mTRP PDCCH

In the enhancement of PDCCH in Rel. 17, an sDCI-based multi-TRP PDCCH repeated transmission mechanism was introduced, to increase transmission reliability of PDCCHs. Specifically, first, each TRP may be associated with a search space set. The two search space sets are associated together through an RRC parameter, and each search space set is associated with a control resource set (CORESET). Based on this, the network (NW) may activate a TCI state for each CORESET to perform downlink beam activation or indication.

(3) Transmission scheme of mTRP PDSCH

In the enhancement of mTRP PDSCH in Rel. 16, two major scenarios were considered: one for enhanced mobile broadband (eMBB) and the other for enhancing ultra reliable and low latency communication (URLLC). Therefore, a plurality of mTRP transmission modes were developed. Specifically, the transmission modes may be roughly classified into two types according to different scheduling modes.

sDCI-mPDSCH: The NW uses one DCI to schedule transmission of two PDSCHs, where the DCI comes from one of the two TRPs, and the NW may dynamically adjust which TRP to use. The two PDSCHs are transmitted through two TRPs in different modes, such as SDM, FDM, and TDM. Such a mode is suitable for TRPs with a desirable backhaul link between them. In addition, in scheduling DCI, one or two TCI states may be included to indicate dynamic switching between sTRP and mTRP transmissions. Specifically, when a code point of a TCI field in DCI indicates one TCI state, which indicates sTRP transmission; when a code point indicates two TCI states, which indicate mTRP transmission, and in this case, each TCI state is mapped onto a specific resource of the TRP transmission, for example, PDSCH scheduling related content such as a code division multiplexing (CDM) group, a demodulation reference signal (DMRS) port, a quantity of transmission layers, a phase-tracking reference signal (PTRS) port, and a redundancy version (RV).

mDCI-mPDSCH: Each TRP independently schedules transmission of a PDSCH by sending a PDCCH. Transmissions of PDSCHs may coincide, partially overlap, or be staggered in time-frequency resources. Such a mode is suitable for TRPs without a desirable backhaul link between them.

### (4) Transmission Scheme of SFN PDCCH/PDSCH

In a high-speed mobile scenario of Rel. 17, for reliability of downlink transmission, a single frequency network (SFN) transmission scheme for multiple TRPs of PDCCHs/PDSCHs is supported, that is, two TRPs use a same time-frequency resource to send a PDCCH and a PDSCH scheduled by the PDCCH. However, in consideration of different spatial positions of the two TRPs, two different TCI states are required to indicate different downlink beam information. Certainly, for flexibility of NW deployment, an sTRP PDCCH is also allowed to schedule SFN PDSCH transmission, and an SFN PDCCH is allowed to schedule sTRP PDSCH transmission.

It should be noted that downlink transmission of multiple transmission reception points (mTRP) in a new radio (NR) system can use only downlink transmission configuration indication (TCI) states in release (Rel) 15/16. Specifically, a physical downlink control channel (PDCCH) and a physical downlink shared channel (PDSCH) use independent beam indication mechanisms. That is, the PDCCH uses a media access control (MAC) control element (CE) to activate one or two TCI states for a control resource set (CORESET) to which the PDCCH belongs; and the PDSCH may use downlink control information (DCI) to dynamically indicate a downlink beam. However, a TCI state indication mechanism related in Rel. 15/16 is applicable only to downlink channels and signals, and is subject to many limitations in application in the NR system, which affects and reduces system performance.

In view of this, this application provides a wireless communication method, to introduce a unified TCI state into the multi-TRP transmission mode, so as to reduce beam indication frequency and resource consumption, thereby improving system performance.

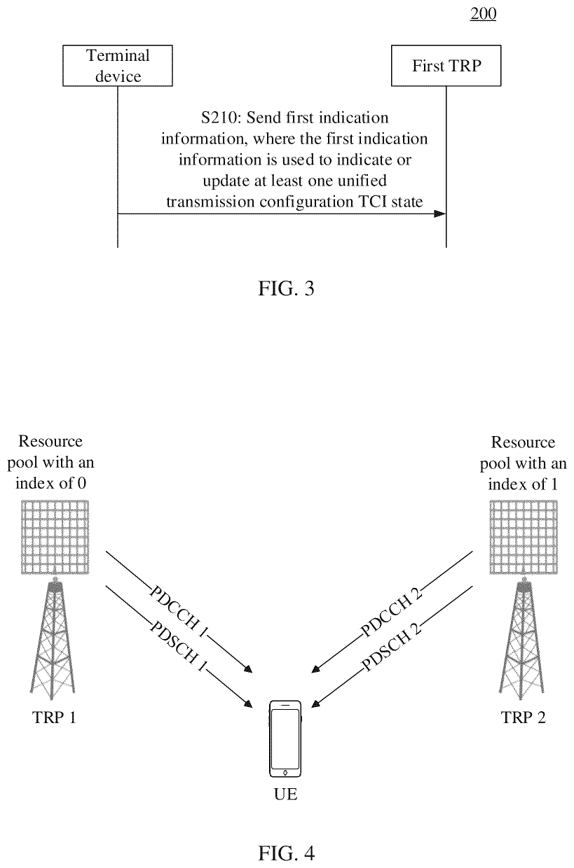

FIG. 3 is a schematic flowchart of a wireless communication method 200 according to an embodiment of this application. The wireless communication method 200 may be performed by a terminal device and a first TRP interactively. The terminal device shown in FIG. 3 may be the terminal device 110 shown in FIG. 1 or the terminal device 130 shown in FIG. 2. The first TRP shown in FIG. 3 can be TRP 121 or TRP 122 shown in FIG. 1, or the network device 140 shown in FIG. 2.

As shown in FIG. 3, the method 200 may include some or all of the following:

S210: The terminal device receives first indication information sent by a first TRP of multiple TRPs.

The first indication information is used to indicate or update at least one unified TCI state.

The first indication information sent by the first TRP of the multiple TRPs is introduced in this embodiment, to indicate or update at least one unified TCI state to the terminal device. This is equivalent to introducing a unified uplink beam management mechanism and/or a unified downlink beam management mechanism for a transmission mode of the multiple TRPs in this application, which can reduce beam indication frequency and reduce resource consumption, thereby improving system performance.

For example, after receiving the first indication information, the terminal device may select or determine at least one unified TCI state from activated unified TCI states based on the first indication information, and receive or send data based on the selected or determined at least one unified TCI state.

For example, after receiving the first indication information, the terminal device may select or determine at least one unified TCI state from activated unified TCI states based on the first indication information, update a currently used unified TCI state based on the selected or determined at least one unified TCI state, and receive or send data based on an updated unified TCI state (that is, the unified TCI state indicated by the first indication information).

The unified TCI state has a strong integration capability within a component carrier (CC), that is, downlink PDCCHs/PDSCHs/aperiodic channel state information reference signals (AP-CSI-RS), uplink physical uplink control channels (PUCCH)/physical uplink shared channels (PUSCH)/sounding reference signals (SRS) (except periodic/semi-persistent SRSs used for beam management), and the like are all integrated into a same beam. Therefore, if the unified TCI state is directly applied to the mDCI-mPDSCH scenario, there needs to be at least multiple sets of independent uplink and downlink beams to correspond to multiple spatially separated TRPs. For example, if an NR system supports a maximum of two TRPs (from different spatial locations) to serve UE, at least two unified TCI states (for example, two joint TCI states or two separate downlink TCI states need to be indicated) are required for downlink beam indication. In addition, more importantly, the unified TCI states require integration of channels and signals of a specific TRP into one downlink beam, and integration of channels and signals of another TRP into another downlink beam. Based on this, in a case that the network indicates one unified TCI state, how to find a corresponding beam or a corresponding TRP (that is, an applicable scope of the unified TCI state) is a technical problem that needs to be further solved in this application.

In some embodiments, after receiving the first indication information, the terminal device may determine an applicable scope of the at least one TCI state based on a characteristic of a transmission mode of the multiple TRPs. For example, if the transmission mode of the multiple TRPs is a transmission mode of multi-downlink control information multi-physical downlink shared channel (Multi-DCI multi-PDSCH, mDCI-mPDSCH), the terminal device may determine the applicable scope of the at least one TCI state based on a characteristic of the transmission mode of mDCI-mPDSCH. For example, if the transmission mode of the multiple TRPs is a transmission mode of single-downlink control information multi-physical downlink shared channel (Single-DCI multi-PDSCH, sDCI-mPDSCH), the terminal device may determine the applicable scope of the at least one TCI state based on a characteristic of the transmission mode of sDCI-mPDSCH. For example, if the transmission mode of the multiple TRPs is a transmission mode of single frequency network (SFN), the terminal device may determine the applicable scope of the at least one TCI state based on a characteristic of the transmission mode of SFN. Optionally, the applicable scope of the at least one TCI state may include: an applicable scope of each one or a specific one of the at least one TCI state, and a resource or a TRP applicable to each or one of the at least one TCI state.

In some embodiments, after receiving the first indication information, the terminal device may determine, based on a characteristic of the transmission mode of the multiple TRPs, a control resource set (CORESET) corresponding to the at least one unified TCI state in the multiple TRPs. In some other embodiments, after receiving the first indication information, the terminal device may determine, based on a characteristic of the transmission mode of the multiple TRPs, a TRP corresponding to the at least one unified TCI state in the multiple TRPs.

In some embodiments, if a transmission mode of the multiple TRPs is a transmission mode of mDCI-mPDSCH, the at least one unified TCI state includes at least one of the following: a joint TCI state, a separate uplink TCI state, or a separate downlink TCI state.

For example, the at least one TCI state may include one or more joint TCI states.

For example, the at least one TCI state may include one separate uplink TCI state.

For example, the at least one TCI state may include one separate downlink TCI state.

For example, the at least one TCI state may include one separate uplink TCI state and one separate downlink TCI state.

For the transmission mode of mDCI-mPDSCH, each TRP performs scheduling separately, with PDCCH scheduling coming from a PDSCH of the same TRP or triggering coming from an aperiodic CSI-RS of the same TRP. There is no need for excessive coordination between different TRPs, and the transmission mode of mDCI-mPDSCH is applicable to a network without a desirable backhaul link between two TRPs, without a need for an excessively high data exchange rate and delay between the two TRPs.

FIG. 4 shows an example of a transmission mode of mDCI-mPDSCH according to an embodiment of this application.

As shown in FIG. 4, CORESETs from a same TRP are grouped into the same CORESET group and associated with one TRP. The CORESET group may also be referred to as a resource pool, a resource pool of CORESETs, or a CORESET resource pool. For example, a resource pool with index 0 is associated with TRP 1, and a resource pool with index 1 is associated with TRP 2.

In some embodiments, the method 200 may further include:

The terminal device determines a first CORESET resource pool to which a CORESET in which downlink control information (DCI) carrying the first indication information is located belongs, as a CORESET resource pool applicable to the at least one unified TCI state.

For example, after receiving the first indication information, the terminal device determines a CORESET in which DCI carrying the first indication information is located, and determines a first CORESET resource pool to which the CORESET in which the DCI carrying the first indication information is located belongs, as a CORESET resource pool applicable to the at least one unified TCI state indicated by the first indication information.

In this embodiment, in consideration of a characteristic of the transmission mode of mDCI-mPDSCH, that is, considering that one or more CORESETs from a same TRP are grouped into the same CORESET group and associated with one TRP, an applicable scope of the at least one unified TCI state indicated by the first indication information is limited to the CORESET resource pool to which the first CORESET belongs in this application. In this way, a same TRP can use a same beam for a PDCCH, a PDSCH, and an aperiodic CSI-RS, while different TRPs use their own indicated beams for downlink transmission, which can ensure data transmission performance.

In some embodiments, the method 200 may further include: determining a TRP of the multiple TRPs that corresponds to the CORESET resource pool applicable to the at least one unified TCI state, as a TRP applicable to the at least one unified TCI state.

For example, after receiving the first indication information, the terminal device determines the first CORESET resource pool to which the first CORESET in which the DCI carrying the first indication information is located belongs, and determines the CORESET resource pool applicable to the at least one unified TCI state indicated by the first indication information. Further, the terminal device may further determine a TRP corresponding to the CORESET resource pool applicable to the at least one unified TCI state as the TRP applicable to the at least one unified TCI state.

For example, the TRP applicable to the at least one unified TCI state is the first TRP.

For example, the terminal device determines the TRP corresponding to the first CORESET resource pool as the TRP applicable to the at least one unified TCI state.

It should be noted that because a unified TCI state is not usually associated with a TRP in a standard protocol, although the TRP associated with the resource pool in which the first CORESET is located is the first TRP, the terminal device can still determine, based on the resource pool in which the first CORESET is located, the TRP applicable to the at least one unified TCI state, which can reduce an extent of modification to the standard protocol and improve compatibility of the at least one unified TCI state.

In this embodiment, when the first indication information indicates at least one unified TCI state, a use effect of the at least one unified TCI state can be improved by clarifying the TRP applicable to the at least one unified TCI state.

In some embodiments, the method 200 may further include: determining that the at least one unified TCI state is a TCI state applicable to at least one of following: a physical downlink control channel PDCCH on a CORESET in the first CORESET resource pool, a physical downlink shared channel PDSCH scheduled by downlink control information DCI received on a CORESET in the first CORESET resource pool, or an aperiodic channel state information reference signal AP-CSI-RS triggered by DCI received on a CORESET in the first CORESET resource pool.

For example, the terminal device may limit an applicable scope of the unified TCI state by using a value of CORESETPoolIndex configured in a CORESET. For a unified TCI state dynamically indicated or updated by DCI in a CORESET from CORESETPoolIndex 0 (or 1), an applicable scope of the unified TCI state is limited to other channels of a TRP associated with CORESETPoolIndex 0 (or 1). That is, a PDCCH applicable to the unified TCI state is limited to a PDCCH with the same CORESETPoolIndex in the belonging CORESET, a PDSCH applicable to the unified TCI state is limited to a PDSCH scheduled by DCI in a CORESET from the same CORESETPoolIndex, and an aperiodic CSI-RS applicable to the unified TCI state is limited to an aperiodic CSI-RS triggered by DCI in a CORESET with the same CORESETPoolIndex. The unified TCI state should not be applicable to another channel and signal associated a CORESET with CORESETPoolIndex of 1 (or 0). “Associated” herein refers to dynamic scheduling of a PDSCH by a PDCCH, or may be triggering of an aperiodic CSI-RS by a PDCCH.

In some embodiments, the first indication information may be carried in a radio resource control (RRC) configuration parameter (that is, RRC signaling).

For example, one or more CORESETs from a same TRP have a same RRC configuration parameter, and the RRC configuration parameter may be a control resource set pool index (CORESETPoolIndex), with a value of 0 or 1. Optionally, if no CORESETPoolIndex is not configured for a CORESET, a default value is 0.

For example, a format of the RRC configuration parameter may be implemented as follows:

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER(0..maxNrofPhysicalResourceBlocks- |

1) OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) OF |

TCI-StateId OPTIONAL, -- Cond NotSIB1-initialBWP

| | |
|---|---|
| tci-StatesPDCCH-ToReleaseList | SEQUENCE(SIZE (1..maxNrofTCI-StatesPDCCH)) OF |

TCI-StateId OPTIONAL, -- Cond NotSIB1-initialBWP

| | |
|---|---|
| tci-PresentInDCI | ENUMERATED {enabled} OPTIONAL, -- Need S |
| pdcch-DMRS-ScramblingID | INTEGER (0..65535)...OPTIONAL, -- Need S |

```
  ...,
  [[
```

| | |
|---|---|
| rb-Offset-r16 | INTEGER (0..5)...OPTIONAL, -- Need S |
| tci-PresentDCI-1-2-r16 | INTEGER (1..3)...OPTIONAL, -- Need S |
| coresetPoolIndex-r16 | INTEGER (0..1)...OPTIONAL, -- Need S |
| controlResourceSetId-v1610 | ControlResourceSetId-v161...OPTIONAL -- Need S |

```
  ]],
  [[
```

| | |
|---|---|
| followUnifiedTCIstate-r17 | ENUMERATED {enabled}...OPTIONAL -- Need R |

```
  ]]
  }
```

In some embodiments, before sending the first indication information to the terminal device, the first TRP may activate or update a unified TCI state of each CORESET resource pool through a media access control (MAC) control element (CE).

For example, the first TRP may activate or update a unified TCI state for a CORESET resource pool through a MAC CE, and may add X=CORESETPoolIndex (1 bit) to activate a set of dedicated unified TCI states for a specific TRP.

For example, when the unified TCI state indicated or updated by the first indication information is applicable to the first CORESET resource pool, the terminal device may select or determine the unified TCI state indicated or updated by the first indication information from unified TCI states activated for the first CORESET resource pool. For example, a unified TCI state included in at least one code point for the first CORESET resource pool may be activated or updated through a MAC CE, and further, a unified TCI state included in a first code point in the at least one code point may be indicated or updated through the first indication information.

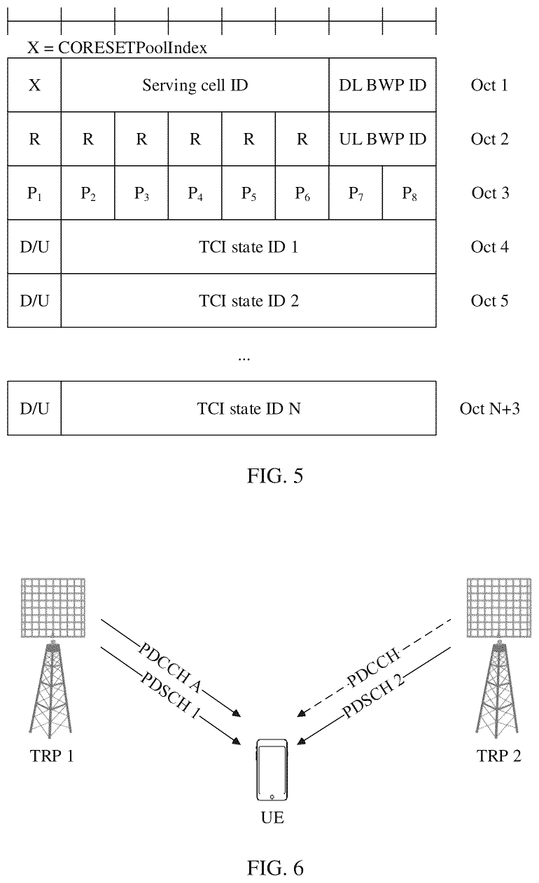

FIG. 5 shows an example of a MAC CE applicable to a transmission mode of mDCI-mPDSCH according to an embodiment of this application.

As shown in FIG. 5, the MAC CE may include N+3 bytes (Oct): Oct 1 to Oct N+3. Oct 1 carries X, a serving cell identifier (Serving Cell ID), and a downlink bandwidth part identifier (Downlink Bandwidth Part ID, DL BWP ID), Oct 2 carries an uplink bandwidth part identifier (Uplink Bandwidth Part ID, DL BWP ID) and R, Oct 3 carries P₁ to P₈, and each Oct of Oct 4 to Oct N+3 carries one TCI state ID (TCI state ID) and one D/U.

The following describes meanings of the fields as an example.

Serving cell identifier: It is used to indicate an identifier of a serving cell to which a MAC CE is applied, and its length may be 5 bits.

Downlink bandwidth identifier: It is used to indicate a DL BWP to which a MAC CE is applied, with a length of 2 bits.

Uplink bandwidth identifier: It is used to indicate a UL BWP to which a MAC CE is applied, with a length of 2 bits.

Pᵢ: It is used to indicate that an i^{th} code point includes multiple TCI states or a single TCI state.

Optionally, if Pᵢ is set to 1, it indicates that the i^{th} code point includes a DL TCI state and a UL TCI state. If Pᵢ is set to 0, it indicates that the i^{th} TCI code point includes only a DL TCI state or a UL TCI state.

D/U: It is used to indicate whether a TCI state ID in the Oct is used for a joint/downlink TCI state or an uplink TCI state.

Optionally, if D/U is set to 1, the TCI state ID in the Oct is used for a joint/downlink TCI state, or if D/U is set to 0, the TCI state ID in the Oct is used for an uplink TCI state.

TCI status ID: It is used to indicate an identifier of a TCI state.

Optionally, if D/U is set to 1, a 7-bit TCI state ID is used. If D/U is set to 0, the most significant bit of the TCI state ID is considered as a reserved bit, and the remaining 6 bits indicate the TCI state ID. Optionally, a maximum quantity of activated TCI states is 16.

X: It is used to indicate CORESETPoolIndex.

That is, it is used to indicate a CORESET applicable to the activated TCI state. If CORESETPoolIndex is set to 1, these activated TCI states are applied to a CORESET (with CORESETPoolIndex set to 1), a scheduled PDSCH, and/or a triggered AP-CSI-RS. If CORESETPoolIndex is set to 0 or does not exist in the MAC CE, these activated TCI states are applied to (one or more) CORESETs, a scheduled PDSCH, and/or a triggered AP-CSI-RS with CORESETPoolIndex set to 0 or not present.

R: It is a reserve bit, and may be set to 0.

In some embodiments, the transmission mode of the multiple TRPs is a transmission mode of sDCI-mPDSCH.

For the transmission mode of sDCI mPDSCH, one piece of DCI schedules two PDSCHs. The NW may choose to send scheduling DCI from any TRP, and then send two PDSCHs from two TRPs to UE. A scheduling mechanism for the transmission mode of sDCI mPDSCH has high flexibility, and the NW can choose to send PDCCH scheduling information from any one of the two TRPs. The network can even adjust transmissions of a same CORESET from different TRPs in different times by activating the Rel. 15/16 TCI state of the CORESET.

The unified TCI state has a strong integration capability within a component carrier (CC), that is, downlink PDCCHs/PDSCHs/aperiodic channel state information reference signals (AP-CSI-RS), uplink physical uplink control channels (PUCCH)/physical uplink shared channels (PUSCH)/sounding reference signals (SRS) (except periodic/semi-persistent SRSs used for beam management), and the like are all integrated into a same beam. Therefore, if the unified TCI state is directly applied to the sDCI-mPDSCH scenario, there needs to be at least multiple sets of independent uplink and downlink beams to correspond to multiple spatially separated TRPs. For example, if an NR system supports a maximum of two TRPs (from different spatial locations) to serve UE, at least two unified TCI states (for example, two joint TCI states or two separate downlink TCI states need to be indicated) are required for downlink beam indication. In addition, more importantly, the unified TCI states require integration of channels and signals of a specific TRP into one downlink beam, and integration of channels and signals of another TRP into another downlink beam. Based on this, how to find a unified TCI state applicable to sDCI in a case that multiple unified TCI states are indicated by the network is a technical problem that needs to be further solved in this application.

FIG. 6 shows an example of a transmission mode of sDCI-mPDSCH according to an embodiment of this application.

As shown in FIG. 6, a PDCCH A sent by a TRP 1 may be used to schedule a PDSCH 1 and a PDSCH 2. That is, after receiving the PDCCH A sent by the TRP 1, the UE may receive the PDSCH 1 from the TRP 1 and the PDSCH 2 from the TRP 2.

In consideration of flexibility, no CORESETPoolIndex is configured for a CORESET in the transmission mode of sDCI-mPDSCH. Therefore, if the first indication information is used to indicate two unified TCI states, a beam of a CORESET (for example, a beam applicable to sDCI used to schedule two PDSCHs) may become ambiguous, meaning that the UE cannot determine which of the two unified TCI states indicated by the first indication information the beam of the CORESET (for example, the beam applicable to the sDCI used to schedule the two PDSCHs) is applicable to. Therefore, for the transmission mode of sDCI-mPDSCH, when the first indication information indicates multiple unified TCI states (such as two unified TCI states), how does the UE determine the beam of the CORESET (for example, the beam applicable to the sDCI used to schedule the two PDSCHs) is a technical problem that needs to be further solved in this application.

In some embodiments, the method 200 may further include: if the at least one unified TCI state is multiple unified TCI states, determining a default unified TCI state of the multiple unified TCI states, as a unified TCI state applicable to single-downlink control information sDCI.

For example, the default unified TCI state may be the 1^{st} unified TCI state of the multiple unified TCI states.

For example, the default unified TCI state may be the last unified TCI state of the multiple unified TCI states.

For example, when the multiple unified TCI states are two unified TCI states, the default unified TCI state may be the 1^{st} or 2^{nd} unified TCI state of the two unified TCI states.

For example, the terminal device may select the 1^{st} unified TCI state from a code point (including two unified TCI states) activated by a MAC CE as an updated beam for the sDCI (that is, an applicable unified TCI state). Certainly, the terminal device may alternatively use the 2^{nd} unified TCI state, and this is not specifically limited in this application.

For example, the first indication information may be used to indicate or update one or more unified TCI states included in a specific code point in at least one code point. Optionally, the at least one code point may be a code point activated or updated by a MAC CE. In other words, the terminal device may obtain, through a MAC CE, at least one activated code point, or at least one code point for updating an activated code point, and indicate or update the at least one unified TCI state by indicating a specific code point in the at least one code point through the first indication information. Optionally, the first indication information may be information carried by a TCI field in DCI.

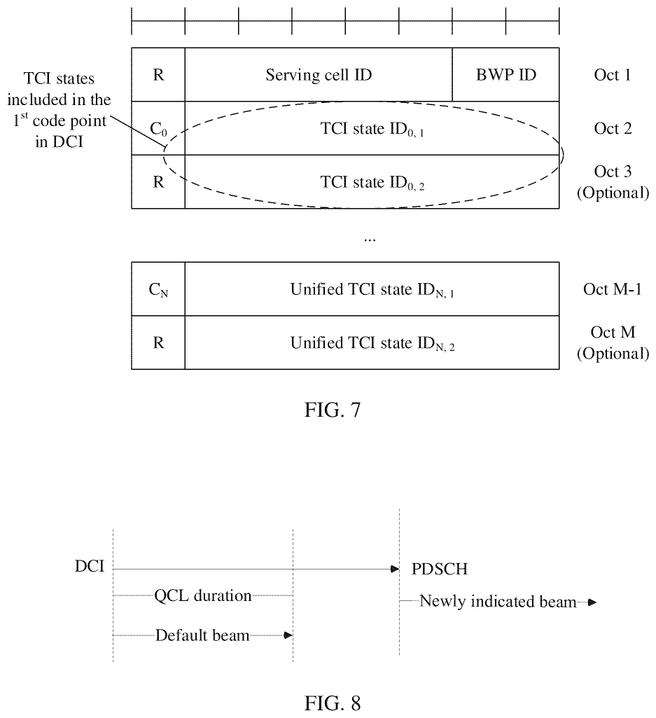

FIG. 7 shows an example of a MAC CE applicable to a transmission mode of sDCI-mPDSCH according to an embodiment of this application.

As shown in FIG. 7, the MAC CE may include M bytes (Oct): Oct 1 to Oct M. Oct 1 carries R, a serving cell identifier (Serving Cell ID), and a bandwidth part identifier (Bandwidth Part ID, BWP ID), Oct 2 carries the 1^{st} code point C₀ and an identifier of the 1^{st} TCI state included C₀ (that is, TCI state ID_{0.1}), Oct 3 carries R and an identifier of the 2^{nd} TCI state included in C₀ (that is, TCI state ID_{0.2}), and so on. Oct M−1 carries the N^{th} code point C_{N} and an identifier of the 1^{st} TCI state included in C_{N} (that is, TCI state ID_{N, 1}), Oct M carries R and an identifier of the 2^{nd} TCI state included in C₀ (that is, TCI state ID_{N, 2}). A byte in which an identifier of the 2^{nd} TCI state included in each code point is an optional byte, for example, Oct 3 and/or Oct M can be optional bytes.

For example, if a code point indicated by the first indication information (to be specific, a TCI field in DCI) is the 1^{st} code point, namely, CO, the TCI state ID_{0.1} and the TCI state ID_{0.2}, as the 1^{st} code point indicated by the TCI field in the DCI, include two unified TCI states. For example, if the TCI field occupies 3 bits in DCI, when values of the 3 bits are 000, the unified TCI state indicated or updated by the first indication information (to be specific, the TCI field in the DCI) is the two unified TCI states included in the 1^{st} code point. Similarly, for C_{N} and its corresponding TCI state ID_{N, 1}, and TCI state ID_{N, 2}, when values of these three bits are 111, the unified TCI state indicated or updated by the first indication information (to be specific, the TCI field in the DCI) is two unified TCI states included in the N^{th} code point.

In some embodiments, the method 200 may further include: if the at least one unified TCI state is multiple unified TCI states, determining at least one of the following as a CORESET applicable to a default unified TCI state of the multiple unified TCI states: a first CORESET in which single-downlink control information sDCI carrying the first indication information is located; another CORESET, different from the first CORESET, on a component carrier CC in which the first CORESET is located; a CORESET with a same unified TCI state as the first CORESET; or another CORESET, different from the first CORESET, in a CORESET group to which the first CORESET belongs.

For example, for different CORESET types, CORESET A always follows the indicated unified TCI state, and whether CORESET B, CORESET C, and CORESET/#0 follow the indicated unified TCI state is separately configured by the NW through RRC signaling.

For a CORESET that is configured by the NW to not follow the at least one unified TCI state indicated by the first indication information, the terminal device may use legacy signaling, namely, a physical downlink control channel (PDCCH) and a physical downlink shared channel (PDSCH) and use independent beam indication mechanisms, that is, in the case a PDCCH, use a media access control (MAC) control element (CE) to activate one or two TCI states for the control resource set (CORESET); or in the case of a PDSCH, use downlink control information (DCI) to dynamically indicate a downlink beam.

For a CORESET that can follow an indicated unified TCI state indicated by the first indication (for example, the at least one unified TCI state indicated by the first indication information), the following cases may be included:

Case 1: A CORESET in which scheduling DCI is located follows an indicated unified TCI state.

Case 2: On one CC, all CORESETs follow an indicated unified TCI state.

Case 3: If a specific CORESET has the same unified TCI state as a CORESET in which scheduling DCI is located, the specific CORESET also follows an indicated unified TCI state.

Case 4: The NW configures two CORESET groups in advance. Within one CORESET group (corresponding to one TRP), if a beam of one CORESET is updated, beams of one or more other CORESETs are also updated accordingly.

FIG. 8 is a schematic diagram of a timeline of a Rel. 15/16 TCI state according to this application.

As shown in FIG. 8, according to the timeline of the Rel. 15/16 TCI state, it is often determined, based on an interval between the scheduling DCI and the scheduled PDSCH, whether to use the indicated beam. When the scheduling interval (the time interval between the DCI and the PDSCH) is greater than a reporting capability of the UE, that is, when the scheduling interval is greater than QCL duration (timeDurationForQCL), the network (NW) may use an indicated new beam to send a PDSCH; otherwise, the NW may use only a default beam (such as an activated beam of a CORESET in which the scheduling DCI is located) to send a PDSCH.

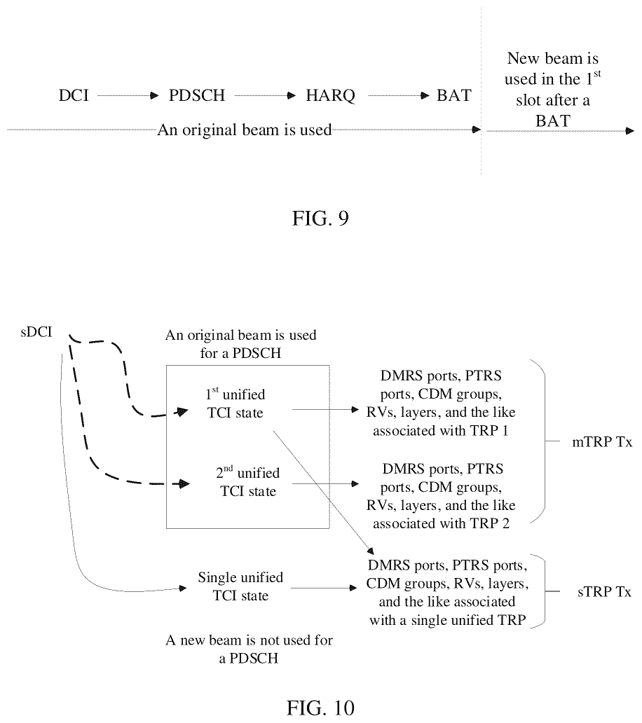

FIG. 9 is a schematic diagram of a timeline of a unified TCI state according to this application.

As shown in FIG. 9, the unified TCI state has its unique timeline, which means that the unified TCI included in DCI carrying PDSCH scheduling information needs to take effect in the 1^{st} slot when a beam application time (BAT) elapses after the user equipment (UE) sends hybrid automatic repeat request ACK (HARQ-ACK) information. The BAT may include a plurality of symbols.

Through comparison between FIG. 8 and FIG. 9, it may be learned that when the NW indicates one unified TCI state through a TCI field in sDCI, an effective time of the unified TCI state is significantly delayed when compared with the legacy TCI state (that is, Rel. 15/16 TCI state). In other words, although the NW indicates the unified TCI state, the indicated unified TCI state is still not applicable before the terminal device receives a PDSCH. In addition, the unified TCI state is associated with PDSCH scheduling information scheduled by sDCI. For example, the 1^{st} unified TCI state is associated with the 1^{st} CDM group, associated with a DMRS port in the CDM group, associated with a PTRS corresponding to a DMRS, associated with some layers transmitted by a TRP (limited only to spatial multiplexing transmission schemes), or associated with an RV version used by a TRP, or other scheduling information. Therefore, how the terminal device determines a unified TCI state applicable to a PDSCH scheduled by sDCI is a technical problem that needs to be further solved in this application. Especially when the terminal device switches from multiple unified TCI states to a single unified TCI state, or when the terminal device switches from a single unified TCI state to multiple unified TCI states, how the terminal device determines a unified TCI state applicable to a scheduled PDSCH is a technical problem to be further solved in this application.

In some embodiments, the method 200 may further include: if the at least one unified TCI state is multiple unified TCI states and a unified TCI state indicated or updated before the first indication information is received is a single unified TCI state, determining the unified TCI state indicated or updated before the first indication information, as a unified TCI state applicable to a physical downlink shared channel PDSCH scheduled by single-downlink control information sDCI carrying the first indication information.

For example, if the at least one unified TCI state is multiple unified TCI states and a unified TCI state indicated or updated before the first indication information is received by the terminal device is a single unified TCI state, the unified TCI state indicated or updated before the first indication information is determined as a unified TCI state applicable to a physical downlink shared channel PDSCH scheduled by single-downlink control information sDCI carrying the first indication information. Correspondingly, if the at least one unified TCI state is multiple unified TCI states and a unified TCI state indicated or updated before the first indication information is sent by the network device is a single unified TCI state, the unified TCI state indicated or updated before the first indication information is determined as a unified TCI state applicable to a physical downlink shared channel PDSCH scheduled by single-downlink control information sDCI carrying the first indication information.

FIG. 10 shows an example of switching from multiple unified TCI states to a single unified TCI state by a terminal device according to an embodiment of this application.

As shown in FIG. 10, a quantity of unified TCI states indicated by the NW may alternatively change from 2 to 1.

Specifically, before the new DCI beam update, sDCI indicates two unified TCI states and parameters such as associated DMRS ports, PTRS ports, CDM groups, RV versions, or layers. In a new beam indication, the NW indicates only a unified TCI state, but this unified TCI state is still not applicable until the terminal device receives a PDSCH. Parameters carried in another field in DCI, such as associated DMRS ports, PTRS ports, CDM groups, RV versions, or layers may be used to indicate transmission from a TRP. In this case, a default unified TCI state may be defined from two unified TCI states indicated by sDCI received before the new beam indication is received from the terminal device, for example, the 1^{st} unified TCI state (available in a slot for receiving the PDSCH) of two unified TCI states indicated by the sDCI received before the new beam indication is received from the terminal device is used to be associated with a corresponding parameter.

In some embodiments, the method 200 may further include: if the at least one unified TCI state is a single unified TCI state and a unified TCI state indicated or updated before the first indication information is multiple unified TCI states, determining a default unified TCI state of the multiple unified TCI states indicated before the first indication information, as a unified TCI state applicable to a physical downlink shared channel PDSCH scheduled by single-downlink control information sDCI carrying the first indication information.

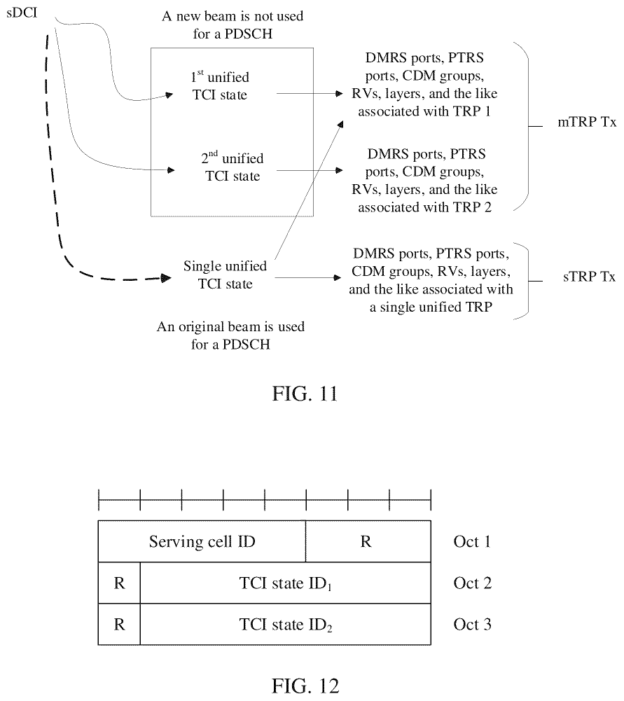

FIG. 11 shows an example of switching from a single unified TCI state to multiple unified TCI states by a terminal device according to an embodiment of this application.

As shown in FIG. 11, a quantity of unified TCI states indicated by the NW may alternatively change from 1 to 2.

Specifically, before a new DCI beam is updated, sDCI indicates a unified TCI state, associated DMRS ports, PTRS ports, CDM groups, RV versions, and layers, or other parameters. In a new beam indication, two unified TCI states and scheduling parameters from two TRPs are provided, but the two unified TCI states are still not applicable before the terminal device receives a PDSCH. In this case, only a currently applicable one unified TCI state can be used to correspond to a scheduling parameter from the 1^{st} TCI state indicated in DCI, such as a DMRS port, a PTRS port, a CDM group, an RV version, a layer, or other parameters.

In some embodiments, the transmission mode of the multiple TRPs is a transmission mode of SFN.

For example, the transmission mode of SFN includes any one of the following: a transmission mode of SFN PDCCH and SFN PDSCH, a transmission mode of SFN PDCCH and STRP PDSCH, or a transmission mode of sTRP PDCCH and SFN PDSCH.

For the transmission mode of SFN, two TRPs serving the UE use same time-frequency resource and different spatial resources (that is, downlink beams) to send a same PDCCH and/or PDSCH. This has an advantage of improving reliability of downlink reception, and is suitable for high-speed mobile scenarios.

For example, a CORESET in which an SFN PDCCH is located requires activation of one or two unified TCI states.

In an implementation, the one or two unified TCI states may be Rel. 15/16 TCI states. In other words, for a downlink control channel, the one or two unified TCI states may indicate a unified TCI state of a corresponding CORESET through RRC signaling (or RRC signaling and MAC signaling).

For example, an SFN PDSCH may be dynamically scheduled by DCI, where a TCI field includes one or two indicated Rel. 15/16 TCI states. In other words, for a downlink data channel, an available TCI state set is indicated through RRC signaling, and some of the TCI states are activated through MAC layer signaling. Finally, one or two TCI states from activated TCI states are indicated through a TCI state indication field in DCI, to be used for a PDSCH scheduled the DCI.

For example, if a unified TCI state indicated by the first indication information points to a joint TCI state or a separate UL TCI state, the unified TCI state indicated by the first indication information may be applicable to an uplink PUCCH, PUSCH, and SRS. In other words, from the perspective of uplink beam management, if the UE supports the use of different antenna panels in uplinks and transmits different uplink beams at the same time, uplink transmission of the UE can also be enhanced. For example, the UE performs uplink SFN transmission and transmits PUCCHs/PUSCHs/SRSs to different TRPs in different spatial directions by using same time-frequency resources, thereby improving coverage of uplink channels and signals.

In some embodiments, the method 200 may further include: determining a CORESET on at least one component carrier CC as a CORESET applicable to the at least one unified TCI state, where the at least one CC includes a CC in which a CORESET of downlink control information DCI carrying the first indication information is located, and the CORESET on the at least one CC shares a unified TCI state.

For example, a quantity of unified TCI states indicated or updated for a CORESET by the network device by using the first indication information is only one or two. Because the unified TCI state is applicable to multiple CORESETs within a cell, it may include CORESET #0 (a cell-specific control channel used by the UE during initial access), and a CORESET type that is configured by the NW to be allowed to follow the indicated unified TCI state (that is, the at least one unified TCI state indicated by the first indication information), for example, CORESET type A, CORESET B, or CORESET C.

For example, the unified TCI state indicated by the first indication information is applicable to configure, on one or more CCs, CORESETs that share beams. Optionally, the multiple CCs may be configured in a CC list to share an indicated beam.

In some embodiments, the transmission mode of SFN is a transmission mode of SFN PDCCH and sTRP PDSCH, and the method 200 may further include: if the at least one unified TCI state is multiple unified TCI states, determining a default unified TCI state of the multiple unified TCI states as a unified TCI state applicable to the sTRP PDSCH.

It should be understood that the default unified TCI state in this application may also be referred to as a unified TCI state by default.

For example, the 1^{st} or 2^{nd} unified TCI state of the multiple unified TCI states is the default unified TCI state.

For example, the last unified TCI state of the multiple unified TCI states is the default unified TCI state.

For example, for the transmission mode of SFN PDCCH and SFN PDSCH, DCI for an SFN PDCCH indicates two unified TCI states, or an MAC CE activates/updates two unified TCI states. If a CORESET in which the SFN PDCCH is located is configured by the NW to be allowed to follow the indicated unified TCI state, the CORESET uses the indicated unified TCI state after a BAT, that is, two beams for receiving a CORESET by the UE and two beams for receiving PDSCHs are consistent, without a need to distinguish which unified TCI state is the 1^{st} or 2^{nd} unified TCI state.

For example, for the transmission mode of SFN PDCCH and sTRP PDSCH, the transmission mode of SFN (that is, the NW uses two downlink beams to send a CORESET) is used for a control channel, and the transmission mode of sTRP (the NW uses one downlink transmission beam) is used for a data channel. If a TCI field in the DCI indicates one unified TCI state (used to schedule a PDSCH from sTRP), this unified TCI state updates one unified TCI state of two unified TCI states activated for the CORESET. For example, this unified TCI state updates the 1^{st} unified TCI state of the two unified TCI states activated for the CORESET, that is, the 1^{st} unified TCI state activated/updated by a MAC CE is selected as the default unified TCI state to be updated under sTRP scheduling. Certainly, in another alternative embodiment, the 2^{nd} unified TCI state may be used as the default unified TCI state to be updated under sTRP scheduling, which is not specifically limited in this application.

For example, for the transmission mode of sTRP PDCCH and SFN PDSCH, when a PDCCH transmitted by the sTRP schedules a PDSCH, two unified TCI states are provided, the PDCCH transmitted by sTRP gives two unified TCI states, which separately indicate an update of a beam for one TRP. This case is similar to the transmission mode of sDCI-mPDSCH. For a specific solution thereof, refer to related content of the transmission mode of sDCI-mPDSCH. Details are not described herein again.

For example, the network device may activate a unified TCI state through a MAC CE, and further, may indicate, through the DCI carrying the first indication information, at least one unified TCI state of activated unified TCI states.

For example, a quantity of unified TCI states activated or updated through a MAC CE may be only one or two.

FIG. 12 shows an example of a MAC CE applicable to a transmission mode of SFN according to an embodiment of this application.

As shown in FIG. 12, a MAC CE may include 3 bytes (Oct): Oct 1 to Oct 3. Oct 1 carries R and a serving cell identifier (Serving Cell ID), Oct 2 carries R and an identifier of the 1^{st} unified TCI state (that is, TCI state ID1), and Oct 3 carries R and an identifier of the 2^{nd} unified TCI state (that is, TCI state ID2). In other words, the unified TCI state may be activated for a serving cell without using a parameter CORESET ID.

In some embodiments, the method 200 may further include: receiving second indication information sent by the first TRP; where the second indication information is used for activating or updating a unified TCI state for each of at least one code point.

In some embodiments, the first indication information is used to indicate or update the 1^{st} code point in the at least one code point.

For example, during updating of the unified TCI state by using DCI carrying first indication information, a plurality of code points (for example, a maximum of eight code points) may be first activated by using a resource pool for a unified TCI state configured through RRC and by using a MAC CE, and then code points including a maximum of four separate UL/DL TCI states may be indicated by the DCI carrying the first indication information. Similarly, a plurality of code points (for example, a maximum of eight code points) may be first activated by using a resource pool with a unified TCI state configured through RRC and by using a MAC CE, and then code points including a maximum of two joint TCI states may be indicated by the DCI carrying the first indication information.

For example, the first indication information may be in DCI format 1_1/1_2 (with or without downlink scheduling), which may be used to dynamically indicate one or more unified TCI states.

In some embodiments, the transmission mode of the multiple TRPs is a transmission mode of mDCI-mPDSCH, and the second indication information further includes a CORESET resource pool to which a CORESET applicable to the at least one code point belongs.

In some embodiments, the second indication information is used to activate or update at least one of following for each code point: multiple joint TCI states; at least one joint TCI state and at least one separate uplink TCI state; at least one joint TCI state and at least one separate downlink TCI state; or at least one separate uplink TCI state and at least one separate downlink TCI state.

For example, when the multiple TRPs are two TRPs, in one implementation, the second indication information is used to activate or update a maximum of four separate TCI states for each code point, that is, for the two TRPs, each TRP indicates one separate downlink TCI state and one separate uplink TCI state, that is, a total of four separate TCI states. In another implementation, the second indication information is used to activate or update a maximum of two joint TCI states for each code point, that is, for the two TRPs, each TRP indicates one joint TCI state.

In some embodiments, the second indication information indicates any one of the following: whether an i^{th} code point in the at least one code point includes both a separate downlink DL TCI state and a separate uplink UL TCI state; the i^{th} code point includes or does not include a 2^{nd} joint TCI state; the i^{th} code point includes or does not include a 2^{nd} pair of separate TCI states; or the i^{th} code point includes or does not include an (X+1)^{th} separate TCI state, where X is an integer greater than 0.

It should be clearly pointed out that, usually, one of the joint TCI state and the separate DL/UL TCI state is configured on one BWP/CC through RRC, that is, the joint TCI state and the separate TCI state are not both configured. In this application, in order to activate the unified TCI state for each TRP more properly, both the joint TCI state and the separate TCI state can be configured on one BWP/CC.

For example, a TCI state may include the following configurations: a TCI state ID, used to identify a TCI state; and QCL Information 1.

Optionally, the TCI state may also include QCL information 2.

A piece of QCL information includes the following information: QCL type configuration, which may be one of QCL type A, QCL type B, QCL type C, or QCL type D; and QCL reference signal configuration, including an ID of a cell in which a reference signal is located, a BWP ID, and an identifier of the reference signal, where the identifier of the reference signal may be a CSI-RS resource ID or an SSB index.

If QCL information 1 and QCL information 2 are both configured, a QCL type of at least one piece of QCL information needs to be one of QCL type A, QCL type B, and QCL type C, and a QCL type of the other piece of QCL information needs to be QCL type D.

The configuration of QCL types is defined as follows:
‘QCL-TypeA’ {Doppler shift, Doppler spread, average delay, delay spread};
‘QCL TypeB’: {Doppler shift, Doppler spread};
‘QCL TypeC’: {Doppler shift, average delay};
‘QCL-TypeD’: {Spatial reception parameter}.

For example, syntax elements of the TCI state may be implemented as follows:

| | |
|---|---|
| TCI-State ::= | SEQUENCE { |
| tci-StateId | TCI-StateId, |
| qcl-Type1 | QCL-Info, |
| qcl-Type2 | QCL-Info OPTIONAL, -- Need R |

...
}

For example, syntax elements of TCI information may be implemented as follows:

| | |
|---|---|
| QCL-Info ::= | SEQUENCE { |
| cell | ServCellIndex OPTIONAL, -- Need R |
| bwp-Id | BWP-Id OPTIONAL, -- Cond CSI-RS-Indicated |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

```
  ...,
  [[
```

| | |
|---|---|
| additionalPCI-r17 | AdditionalPCIIndex-r17 OPTIONAL -- Need R |

```
  --Editor's note: Can be discussed if ASN1 overhead reasons should have another way to implement
than using this extension.
  --Editor's note: Needed in Rel-15/16 TCI state for mTRP intercell and in Rel-17 TCI state for BM
intercell
  ]]
  }
```

For example, syntax elements of the DL TCI state or joint TCI state may be implemented as follows:

| | |
|---|---|
| DLorJoint-TCIState-r17 ::= | SEQUENCE { |
| tci-StateUnifiedId-r17 | TCI-StateId, |
| qcl-Type1-r17 | QCL-Info-r17, |
| qcl-Type2-r17 | QCL-Info-r17OPTIONAL, -- Need R |
| ul-powerControl-r17 | Uplink-powerControlId-r17OPTIONAL, -- Need R |
| pathlossReferenceRS-Id-r17 | PUSCH-Pathloss ReferenceRS-Id -r17OPTIONAL -- Need S |

}

For example, syntax elements of the UL TCI state may be implemented as follows:

| | |
|---|---|
| UL-TCIState-r17 ::= | SEQUENCE { |
| UL-TCIState-Id-r17 | UL-TCIState-Id-r17, |
| servingCellId-r17 | ServCellIndex-r17 OPTIONAL, -- Need S |
| referenceSignal-r17 | CHOICE { |
| ssb-Index-r17 | SSB-Index-r17, |
| csi-RS-Index-r17 | NZP-CSI-RS-ResourceId-r17, |
| srs-r17 | PUCCH-SRS-r17 |

},

| | |
|---|---|
| additionalPCI-r17 | AdditionalPCIIndex-r17 OPTIONAL, -- Need R |
| ul-powerControl-r17 | Uplink-powerControlId-r17 OPTIONAL, -- Need R |
| pathlossReferenceRS-Id-r17 | PUSCH-PathlossReferenceRS-Id-r17 OPTIONAL -- |

Need S
}

For example, the second indication information is used to activate or update two joint TCI states for each code point; correspondingly, the second indication information is used to indicate whether an i^{th} code point in the at least one code point includes or does not include the 2^{nd} joint TCI state.

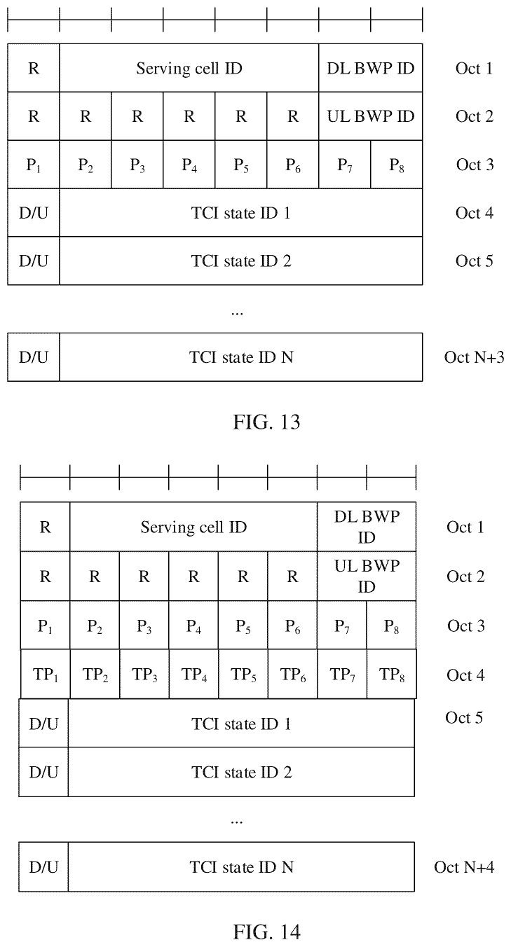

FIG. 13 shows an example of a MAC CE carrying second indication information according to an embodiment of this application.

As shown in FIG. 13, for two joint TCI states, it is assumed that an NW has configured a resource pool for joint TCI states through RRC signaling according to a format of a MAC CE. Based on this, a MAC CE carrying the second indication information may include N+3 bytes (Oct): Oct 1 to Oct N+3. Oct 1 carries R, a serving cell identifier (Serving Cell ID), and a downlink bandwidth part identifier (DL BWP ID). Oct 2 carries R and an uplink bandwidth part identifier (DL BWP ID). Oct 3 carries P₁ to P₈. If Pᵢ is 1, it indicates that a plurality of joint TCI states (two TCI states under multi-TRP operation) are activated or updated by an i^{th} code point in a TCI field in DCI. If Pᵢ is 0, it indicates that only one joint TCI state is activated or updated by an i^{th} code point of a TCI field in DCI. UE may determine, through all Pᵢ, a length of the MAC CE carrying the second indication information and a total quantity of corresponding joint TCI states. Each Oct of Oct 4 to Oct N+3 carries one TCI state identifier (TCI state ID) and one D/U.

It should be noted that, in this embodiment, because the joint TCI state is configured on a CC/BWP, D/U in the MAC CE may not represent any information, that is, the UE may ignore it.

For example, the second indication information is used to activate or update four separate TCI states for each code point; correspondingly, the second indication information is used to indicate whether an i^{th} code point in at least one code point includes or does not include the 2^{nd} separate TCI state in the 1^{st} pair of separate TCI states. Further, the second indication information is further used to indicate whether the i^{th} code point includes or does not include the 2^{nd} separate TCI state.

FIG. 14 shows another example of a MAC CE carrying second indication information according to an embodiment of this application.

As shown in FIG. 14, for four separate TCI states, it is assumed that an NW has configured a resource pool for separate TCI states through RRC signaling according to a format of a MAC CE. Based on this, a MAC CE carrying the second indication information may include N+4 bytes (Oct): Oct 1 to Oct N+4. Oct 1 carries R, a serving cell identifier (Serving Cell ID), and a downlink bandwidth part identifier (DL BWP ID). Oct 2 carries R and an uplink bandwidth part identifier (DL BWP ID).

Oct 3 Carry P₁ to P₈. If Pᵢ is 1, it indicates that the MAC CE has activated the 1^{st} pair of separate TCI states for the i^{th} code point in a TCI field in DCI, that is, the 1^{st} separate TCI state and the 2^{nd} separate TCI state. If Pᵢ is 0, it indicates that the MAC CE has activated one separate TCI state for the i^{th} code point in a TCI field in DCI, that is, the 1^{st} separate TCI state.

Oct 4 carries TP₁ to TP₈. TPᵢ represents whether the i^{th} code point in the TCI field in the DCI still has the 2^{nd} pair of separate TCI states, that is, whether there is still the 3^{rd} separate TCI state and the 4th separate TCI state. Optionally, TP₁ is a variable with a length of a plurality of bits (for example, 8 bits). When TPᵢ is 0, it indicates that the i^{th} code point in the TCI field in the DCI does not have the 2^{nd} pair of separate TCI states. When TPᵢ is 1, it indicates that the i^{th} code point in the TCI field in the DCI has the 2^{nd} pair of separate TCI states.

Each Oct of Oct 5 to Oct N+4 carries one TCI state identifier (TCI state ID) and one D/U.

In consideration of flexibility of the unified TCI state indicated by the second indication information, for activation or updating of the 2^{nd} pair of separate TCI states, only one separate TCI state may be activated or updated.

For example, the second indication information is used to activate or update four separate TCI states for each code point; correspondingly, the second indication information is used to indicate whether an i^{th} code point in the at least one code point includes or does not include an (X+1)^{th} separate TCI state.

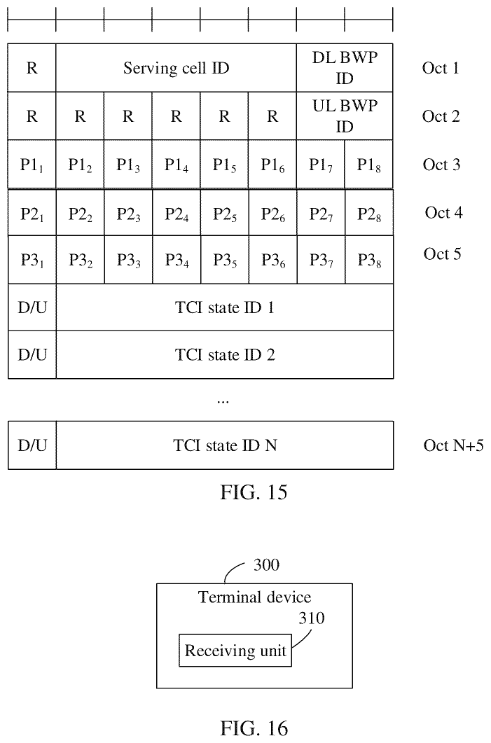

FIG. 15 shows another example of a MAC CE carrying second indication information according to an embodiment of this application.

As shown in FIG. 15, for four separate TCI states, it is assumed that an NW has configured a resource pool for separate TCI states through RRC signaling according to a format of a MAC CE. Based on this, a MAC CE carrying the second indication information may include N+5 bytes (Oct): Oct 1 to Oct N+5. Oct 1 carries R, a serving cell identifier (Serving Cell ID), and a downlink bandwidth part identifier (DL BWP ID). Oct 2 carries R and an uplink bandwidth part identifier (DL BWP ID). Oct 3 to Oct 5 carry PX₁ to PX₈, where X=1, 2, 3. PXᵢ indicates whether the MAC CE has activated/updated the (X+1)^{th} separate TCI state. If PXᵢ is 1, it indicates that the MAC CE activates or updates the (X+1)^{th} separate TCI state of the i^{th} code point in the TCI field in the DCI. If PXᵢ is 0, it indicates that the MAC CE does activates or does not update the (X+1)^{th} separate TCI state of the i^{th} code point in the TCI field in the DCI. Each Oct of Oct 6 to Oct N+5 carries one TCI state of identifier (TCI state ID) and one D/U.

It should be understood that for foregoing related solutions of determining, by a network device, a CORESET resource pool applicable to at least one TCI state, a TRP, and an applicable CORESET, and for solutions of determining, by the network device, a unified TCI state applicable to sDCI and a unified TCI state applicable to a PDSCH scheduled by sDCI carrying first indication information, reference may be made to related content on the terminal device side. To avoid repetition, details are not described herein again.

The foregoing describes in detail the preferred implementations of this application with reference to the accompanying drawings. However, this application is not limited to specific details in the foregoing implementation. Within a technical concept scope of this application, a plurality of simple variations of the technical solutions of this application may be performed, and these simple variations are all within the protection scope of this application. For example, each specific technical feature described in the foregoing specific implementations may be combined in any suitable manner without contradiction. To avoid unnecessary repetition, various possible combination manners are not described otherwise in this application. For another example, any combination may also be performed between different implementations of this application, provided that the combination is not contrary to the idea of this application, the combination shall also be considered as the content disclosed in this application.

It should be further understood that, in method embodiments of this application, sequence numbers of the foregoing processes do not mean execution sequences. The execution sequences of the processes should be determined according to functions and internal logic of the processes, and should not be construed as any limitation on the implementation processes of embodiments of this application. In addition, in embodiments of this application, the terms “downlink” and “uplink” are used to indicate a transmission direction of a signal or data, where “downlink” indicates that a transmission direction of a signal or data is a first direction from a station to user equipment in a cell, and “uplink” indicates that a transmission direction of a signal or data is a second direction from user equipment in a cell to a station. For example, a “downlink signal” indicates that a transmission direction of the signal is the first direction. In addition, in embodiments of this application, the term “and/or” is merely used to describe an association relationship between associated objects, and represents that there may be three relationships. Specifically, A and/or B may represent three cases: only A exists, both A and B exist, and only B exists. In addition, the character “/” in the specification generally indicates an “or” relationship between the associated objects.

The foregoing describes the method embodiments of this application in detail with reference to FIG. 5 to FIG. 15. The following describes the apparatus embodiments of this application in detail with reference to FIG. 16 to FIG. 19.

FIG. 16 is a schematic block diagram of a terminal device 300 according to an embodiment of this application.

As shown in FIG. 16, the terminal device 300 may include: a receiving unit 310, configured to receive first indication information sent by a first TRP of multiple transmission reception points TRPs; where the first indication information is used to indicate or update at least one unified transmission configuration indication TCI state.

In some embodiments, if a transmission mode of the multiple TRPs is a transmission mode of multi-downlink control information multi-physical downlink shared channel mDCI-mPDSCH, the at least one unified TCI state includes at least one of the following: a joint TCI state, a separate uplink TCI state, or a separate downlink TCI state.

In some embodiments, the receiving unit 310 is further configured to: determine a first CORESET resource pool to which a CORESET in which downlink control information DCI carrying the first indication information is located belongs, as a CORESET resource pool applicable to the at least one unified TCI state.

In some embodiments, the receiving unit 310 is further configured to: determine a TRP of the multiple TRPs that corresponds to the CORESET resource pool applicable to the at least one unified TCI state, as a TRP applicable to the at least one unified TCI state.

In some embodiments, the receiving unit 310 is further configured to: determine that the at least one unified TCI state is a TCI state applicable to at least one of following: a physical downlink control channel PDCCH on a CORESET in the first CORESET resource pool, a physical downlink shared channel PDSCH scheduled by downlink control information DCI received on a CORESET in the first CORESET resource pool, or an aperiodic channel state information reference signal AP-CSI-RS triggered by DCI received on a CORESET in the first CORESET resource pool.

In some embodiments, a transmission mode of the multiple TRPs is a transmission mode of single-downlink control information multi-physical downlink shared channel sDCI-mPDSCH.

In some embodiments, the receiving unit 310 is further configured to: if the at least one unified TCI state is multiple unified TCI states, determine a default unified TCI state of the multiple unified TCI states, as a unified TCI state applicable to single-downlink control information sDCI.

In some embodiments, the receiving unit 310 is further configured to: if the at least one unified TCI state is multiple unified TCI states, determine at least one of the following as a CORESET applicable to a default unified TCI state of the multiple unified TCI states: a first CORESET in which single-downlink control information sDCI carrying the first indication information is located; another CORESET, different from the first CORESET, on a component carrier CC in which the first CORESET is located; a CORESET with a same unified TCI state as the first CORESET; or another CORESET, different from the first CORESET, in a CORESET group to which the first CORESET belongs.

In some embodiments, the receiving unit 310 is further configured to: if the at least one unified TCI state is multiple unified TCI states and a unified TCI state indicated or updated before the first indication information is received is a single unified TCI state, determining the unified TCI state indicated or updated before the first indication information, as a unified TCI state applicable to a physical downlink shared channel PDSCH scheduled by single-downlink control information sDCI carrying the first indication information.

In some embodiments, the receiving unit 310 is further configured to: if the at least one unified TCI state is a single unified TCI state and a unified TCI state indicated or updated before the first indication information is multiple unified TCI states, determining a default unified TCI state of the multiple unified TCI states indicated before the first indication information, as a unified TCI state applicable to a physical downlink shared channel PDSCH scheduled by single-downlink control information sDCI carrying the first indication information.

In some embodiments, a transmission mode of the multiple TRPs is a transmission mode of single-frequency network SFN, and the transmission mode of SFN includes any one of the following: a transmission mode of SFN physical downlink control channel PDCCH and SFN physical downlink shared channel PDSCH, a transmission mode of SFN PDCCH and single-transmission reception point sTRP PDSCH, or a transmission mode of sDCI and SFN PDSCH.

In some embodiments, the receiving unit 310 is further configured to: determine a control resource set CORESET on at least one component carrier CC as a CORESET applicable to the at least one unified TCI state, where the at least one CC includes a CC in which a CORESET of downlink control information DCI carrying the first indication information is located, and the CORESET on the at least one CC shares a unified TCI state.

In some embodiments, the transmission mode of SFN is a transmission mode of SFN

PDCCH and single-transmission reception point sTRP PDSCH; and the receiving unit 310 is further configured to: if the at least one unified TCI state is multiple unified TCI states, determine a default unified TCI state of the multiple unified TCI states as a unified TCI state applicable to the sTRP PDSCH.

In some embodiments, the receiving unit 310 is further configured to: receive second indication information sent by the first TRP; where the second indication information is used for activating or updating a unified TCI state for each of at least one code point.

In some embodiments, the first indication information is used to indicate or update the 1^{st} code point in the at least one code point.

In some embodiments, the transmission mode of the multiple TRPs is the transmission mode of multi-downlink control information multi-physical downlink shared channel mDCI-mPDSCH, and the second indication information further includes a CORESET resource pool to which a CORESET applicable to the at least one code point belongs.

In some embodiments, the second indication information is used to activate or update at least one of following for each code point: multiple joint TCI states; at least one joint TCI state and at least one separate uplink TCI state; at least one joint TCI state and at least one separate downlink TCI state; or at least one separate uplink TCI state and at least one separate downlink TCI state.

In some embodiments, the second indication information indicates any one of the following: whether an i^{th} code point in the at least one code point includes both a separate downlink DL TCI state and a separate uplink UL TCI state; the i^{th} code point includes or does not include a 2^{nd} joint TCI state; the i^{th} code point includes or does not include a 2^{nd} pair of separate TCI states; or the i^{th} code point includes or does not include an (X+1)^{th} separate TCI state, where X is an integer greater than 0.

It should be understood that the apparatus embodiments may correspond to the method embodiments, and for similar descriptions, reference may be made to the method embodiments. Specifically, the terminal device 300 shown in FIG. 16 may correspond to the corresponding subject in the method 200 for executing the embodiment of this application, and the aforementioned and other operations and/or functions of each unit in the terminal device 300 are respectively to implement the corresponding processes in the methods provided by the embodiment of this application. For simplicity, they will not be repeated here.

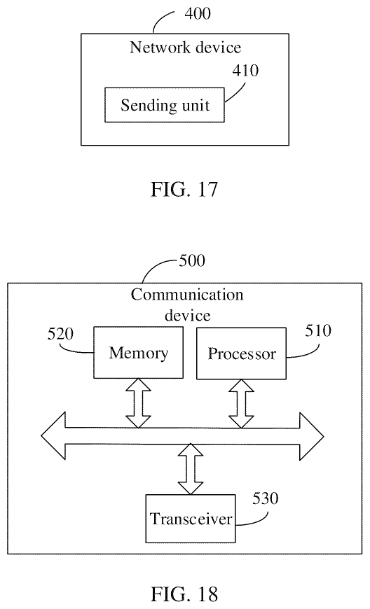

FIG. 17 is a schematic block diagram of a network device 400 according to an embodiment of this application.

As shown in FIG. 17, the network device 400 may include: a sending unit 410, configured to send first indication information to the terminal device; where the first indication information is used to indicate or update at least one unified transmission configuration indication TCI state.

In some embodiments, if a transmission mode of the multiple TRPs is a transmission mode of multi-downlink control information multi-physical downlink shared channel mDCI-mPDSCH, the at least one unified TCI state includes at least one of the following: a joint TCI state, a separate uplink TCI state, or a separate downlink TCI state.

In some embodiments, the sending unit 410 is further configured to: determine a first CORESET resource pool to which a CORESET in which downlink control information DCI carrying the first indication information is located belongs, as a CORESET resource pool applicable to the at least one unified TCI state.

In some embodiments, the sending unit 410 is further configured to: determining a TRP of the multiple TRPs that corresponds to the CORESET resource pool applicable to the at least one unified TCI state, as a TRP applicable to the at least one unified TCI state.

In some embodiments, the sending unit 410 is further configured to: determine that the at least one unified TCI state is a TCI state applicable to at least one of following: a physical downlink control channel PDCCH on a CORESET in the first CORESET resource pool, a physical downlink shared channel PDSCH scheduled by downlink control information DCI received on a CORESET in the first CORESET resource pool, or an aperiodic channel state information reference signal AP-CSI-RS triggered by DCI received on a CORESET in the first CORESET resource pool.

In some embodiments, a transmission mode of the multiple TRPs is a transmission mode of single-downlink control information multi-physical downlink shared channel sDCI-mPDSCH.

In some embodiments, the sending unit 410 is further configured to: if the at least one unified TCI state is multiple unified TCI states, determining a default unified TCI state of the multiple unified TCI states, as a unified TCI state applicable to single-downlink control information sDCI.

In some embodiments, the sending unit 410 is further configured to: if the at least one unified TCI state is multiple unified TCI states, determining at least one of the following as a CORESET applicable to a default unified TCI state of the multiple unified TCI states: a first CORESET in which single-downlink control information sDCI carrying the first indication information is located; another CORESET, different from the first CORESET, on a component carrier CC in which the first CORESET is located; a CORESET with a same unified TCI state as the first CORESET; or another CORESET, different from the first CORESET, in a CORESET group to which the first CORESET belongs.

In some embodiments, the sending unit 410 is further configured to: if the at least one unified TCI state is multiple unified TCI states and a unified TCI state indicated or updated before the first indication information is sent is a single unified TCI state, determine the unified TCI state indicated or updated before the first indication information, as a unified TCI state applicable to a physical downlink shared channel PDSCH scheduled by single-downlink control information sDCI carrying the first indication information.

In some embodiments, the sending unit 410 is further configured to: if the at least one unified TCI state is a single unified TCI state and a unified TCI state indicated or updated before the first indication information is multiple unified TCI states, determining a default unified TCI state of the multiple unified TCI states indicated before the first indication information, as a unified TCI state applicable to a physical downlink shared channel PDSCH scheduled by single-downlink control information sDCI carrying the first indication information.

In some embodiments, a transmission mode of the multiple TRPs is a transmission mode of single-frequency network SFN, and the transmission mode of SFN includes any one of the following: a transmission mode of SFN physical downlink control channel PDCCH and SFN physical downlink shared channel PDSCH, a transmission mode of SFN PDCCH and single-transmission reception point sTRP PDSCH, or a transmission mode of sDCI and SFN PDSCH.

In some embodiments, the sending unit 410 is further configured to: determine a control resource set CORESET on at least one component carrier CC as a CORESET applicable to the at least one unified TCI state, where the at least one CC includes a CC in which a CORESET of downlink control information DCI carrying the first indication information is located, and the CORESET on the at least one CC shares a unified TCI state.

In some embodiments, the transmission mode of SFN is a transmission mode of SFN

PDCCH and single-transmission reception point sTRP PDSCH; and the sending unit 410 is further configured to: if the at least one unified TCI state is multiple unified TCI states, determine a default unified TCI state of the multiple unified TCI states as a unified TCI state applicable to the sTRP PDSCH.

In some embodiments, the sending unit 410 is further configured to: send second indication information to the terminal device; where the second indication information is used for activating or updating a unified TCI state for each of at least one code point.

In some embodiments, the first indication information is used to indicate or update the 1^{st} code point in the at least one code point.

In some embodiments, the transmission mode of the multiple TRPs is the transmission mode of multi-downlink control information multi-physical downlink shared channel mDCI-mPDSCH, and the second indication information further includes a CORESET resource pool to which a CORESET applicable to the at least one code point belongs.

In some embodiments, the second indication information is used to activate or update at least one of following for each code point: multiple joint TCI states; at least one joint TCI state and at least one separate uplink TCI state; at least one joint TCI state and at least one separate downlink TCI state; or at least one separate uplink TCI state and at least one separate downlink TCI state.

In some embodiments, the second indication information indicates any one of the following: whether an i^{th} code point in the at least one code point includes both a separate downlink DL TCI state and a separate uplink UL TCI state; the i^{th} code point includes or does not include a 2^{nd} joint TCI state; the i^{th} code point includes or does not include a 2^{nd} pair of separate TCI states; or the i^{th} code point includes or does not include an (X+1)^{th} separate TCI state, where X is an integer greater than 0.

It should be understood that the apparatus embodiments correspond to the method embodiments, and for similar descriptions, reference may be made to the method embodiments. Specifically, the network device 400 shown in FIG. 17 may correspond to a corresponding body (that is, a first TRP) that executes the method 200 in embodiments of this application, and the foregoing and other operations and/or functions of the units in the network device 400 are respectively used to implement corresponding procedures in the methods provided in embodiments of this application. For brevity, details are not described herein again.

The foregoing describes the communication device in embodiments of this application from a perspective of a functional module with reference to the accompanying drawings. It should be understood that the functional module may be implemented in a hardware form, may be implemented in an instruction in a software form, or may be implemented in a combination of hardware and a software module. Specifically, the steps of the method embodiments in embodiments of this application may be completed by using an integrated logic circuit of hardware in a processor and/or an instruction in a form of software. The steps of the methods disclosed with reference to embodiments of this application may be directly executed by a hardware decoding processor, or may be executed by using a combination of hardware and a software module in a decoding processor. Optionally, the software module may be located in a mature storage medium in the art such as a random access memory, a flash memory, a read-only memory, a programmable read-only memory, an electrically erasable programmable memory, or a register. The storage medium is located in a memory. The processor reads information from the memory, and performs the steps in the foregoing method embodiments in combination with hardware in the processor.

For example, the processing unit and the communication unit described above may be implemented by a processor and a transceiver, respectively.

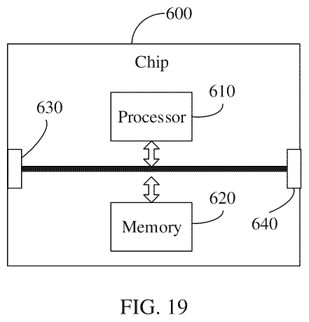

FIG. 19 is a schematic diagram of a structure of a communication device 500 according to an embodiment of this application.

As shown in FIG. 19, the communication device 500 may include a processor 510.

The processor 510 may invoke and run a computer program from a memory to implement the method in embodiments of this application.

As shown in FIG. 19, the communication device 500 may further include a memory 520.

The memory 520 may be configured to store indication information, and may be further configured to store code, an instruction, and the like that are executed by the processor 510. The processor 510 may invoke and run a computer program from the memory 520 to implement the method in embodiments of this application. The memory 520 may be a separate component independent of the processor 510, or may be integrated into the processor 510.

As shown in FIG. 19, the communication device 500 may further include a transceiver 530.

The processor 510 may control the transceiver 530 to communicate with another device. Specifically, the processor 510 may send information or data to the another device, or receive information or data sent by the another device. The transceiver 530 may include a transmitting set and a receiving set. The transceiver 530 may further include an antenna, and a quantity of antennas may be one or more.

It should be understood that components in the communication device 500 are connected by using a bus system. In addition to a data bus, the bus system includes a power bus, a control bus, and a status signal bus.

It should be further understood that the communication device 500 may be a terminal device in embodiments of this application, and the communication device 500 may implement a corresponding procedure implemented by the terminal device in the methods in embodiments of this application. That is, the communication device 500 in embodiments of this application may correspond to the terminal device 300 in embodiments of this application, and may correspond to a corresponding body that executes the method 200 according to embodiments of this application. For brevity, details are not described herein again. Similarly, the communication device 500 may be a first TRP in embodiments of this application, and the communication device 500 may implement a corresponding procedure implemented by the first TRP in the methods in embodiments of this application. That is, the communication device 500 in this embodiment of this application may correspond to the network device 400 in embodiments of this application, and may correspond to a corresponding body that executes the method 200 according to embodiments of this application. For brevity, details are not described herein again.

In addition, an embodiment of this application further provides a chip.

For example, the chip may be an integrated circuit chip, which has a signal processing capability, and may implement or execute the methods, steps, and logical block diagrams disclosed in embodiments of this application. The chip may also be referred to as a system-level chip, a system chip, a chip system, or a system-on-chip, or the like. Optionally, the chip may be applied to various communication devices, so that a communication device on which the chip is installed can execute the methods, steps, and logical block diagrams disclosed in embodiments of this application.

FIG. 19 is a schematic structural diagram of a chip 600 according to an embodiment of this application.

As shown in FIG. 19, the chip 600 includes a processor 610.

The processor 610 may invoke and run a computer program from a memory to implement the method in embodiments of this application.

As shown in FIG. 19, the chip 600 may further include a memory 620.

The processor 610 may invoke and run a computer program from the memory 620 to implement the method in embodiments of this application. The memory 620 may be configured to store indication information, and may be further configured to store code, an instruction, and the like that are executed by the processor 610. The memory 620 may be a separate component independent of the processor 610, or may be integrated into the processor 610.

As shown in FIG. 19, the chip 600 may further include an input interface 630.

The processor 610 may control the input interface 630 to communicate with another device or chip, and specifically, may obtain information or data transmitted by the another device or chip.

As shown in FIG. 19, the chip 600 may further include an output interface 640.

The processor 610 may control the output interface 640 to communicate with another device or chip, and specifically, may output information or data to the another device or chip.

It should be understood that the chip 600 may be applied to a first TRP in embodiments of this application, and the chip may implement a corresponding procedure implemented by the first TRP in the methods in embodiments of this application, or may implement a corresponding procedure implemented by a terminal device in the methods in embodiments of this application. For brevity, details are not described herein again.

It should be further understood that components in the chip 600 are connected by using a bus system. In addition to a data bus, the bus system further includes a power bus, a control bus, and a status signal bus.

The foregoing processor may include but is not limited to: a general-purpose processor, a digital signal processor (DSP), an application-specific integrated circuit (ASIC), a field programmable gate array (FPGA) or another programmable logic device, a discrete gate or a transistor logic device, or a discrete hardware component.

The processor may be configured to implement or execute the methods, steps, and logical block diagrams disclosed in embodiments of this application. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

The foregoing memory includes but is not limited to: a volatile memory and/or a non-volatile memory. The non-volatile memory may be a read-only memory (ROM), a programmable read-only memory (PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DR RAM).

It should be noted that the memories described herein are intended to include these and any other suitable types of memories.

An embodiment of this application further provides a computer-readable storage medium, configured to store a computer program. The computer-readable storage medium stores one or more programs, and the one or more programs include an instruction. When the instruction is executed by a portable electronic device including a plurality of application programs, the portable electronic device can perform the wireless communication method provided in this application. Optionally, the computer-readable storage medium may be applied to a network device in embodiments of this application, and the computer program causes a computer to execute a corresponding procedure implemented by the network device in the methods in embodiments of this application. For brevity, details are not described herein again. Optionally, the computer-readable storage medium may be applied to a mobile terminal or a terminal device in embodiments of this application, and the computer program causes a computer to execute a corresponding procedure implemented by the mobile terminal or the terminal device in the methods in embodiments of this application. For brevity, details are not described herein again.

An embodiment of this application further provides a computer program product, including a computer program. Optionally, the computer program product may be applied to a network device in embodiments of this application, and the computer program causes a computer to execute a corresponding procedure implemented by the network device in the methods in embodiments of this application. For brevity, details are not described herein again. Optionally, the computer program product may be applied to a mobile terminal or a terminal device in embodiments of this application, and the computer program causes a computer to execute a corresponding procedure implemented by the mobile terminal or the terminal device in the methods in embodiments of this application. For brevity, details are not described herein again.

An embodiment of this application further provides a computer program. When the computer program is executed by a computer, the computer can perform the wireless communication methods provided in this application. Optionally, the computer program may be applied to a network device in embodiments of this application. When the computer program runs on a computer, the computer executes a corresponding procedure implemented by the network device in the methods in embodiments of this application. For brevity, details are not described herein again. Optionally, the computer program may be applied to a mobile terminal or a terminal device in embodiments of this application. When the computer program runs on a computer, the computer executes a corresponding procedure implemented by the mobile terminal or the terminal device in the methods in embodiments of this application. For brevity, details are not described herein again.

An embodiment of this application further provides a communication system. The communication system may include the terminal device and the network device in the foregoing, so as to form the communication system 100 shown in FIG. 1. For brevity, details are not described herein again. It should be noted that the terms “system” and the like in this specification may also be referred to as a “network management architecture”, a “network system”, or the like.

It should be further understood that terms used in embodiments of this application and the appended claims are merely intended to describe specific embodiments, but are not intended to limit embodiments of this application. For example, the singular forms of “a/an”, “said”, “described above”, and “the” used in embodiments of this application and the appended claims are also intended to include plural forms, unless the context clearly implies otherwise.

A person of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraints of the technical solutions. A person skilled in the art may use different methods for each specific application to implement the described functions, but this implementation shall not be considered as beyond the scope of embodiments of this application. When the functions are implemented in a form of a software functional unit and sold or used as an independent product, the functions may be stored in a computer-readable storage medium. Based on such an understanding, the technical solutions in embodiments of this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods in embodiments of this application. The foregoing storage medium includes any medium that can store program code, such as a USB flash drive, a removable hard disk, a read-only memory, a random access memory, a magnetic disk, or an optical disc.

It may be aware by a person skilled in the art that, for convenience and brevity of description, for a specific working process of the foregoing described systems, apparatuses, and units, refer to corresponding processes in the foregoing method embodiments, and details are not described herein again. In the several embodiments provided in this application, it should be understood that the disclosed systems, apparatuses, and methods may be implemented in another manner. For example, the unit division, or module division, or component division in the foregoing apparatus embodiments is merely a logical function division, and there may be other divisions in actual implementation. For example, a plurality of units or modules or components may be combined or integrated into another system, or some units or modules or components may be ignored or omitted. For another example, the foregoing units, modules, or components described as separate or display components may be or may not be physically separated, that is, may be located in one place, or may be distributed on a plurality of network units. Some or all of the units, modules, or components may be selected according to an actual need to achieve the objectives of embodiments of this application. Finally, it should be noted that the foregoing displayed or discussed mutual coupling or direct coupling or communication connections may be implemented by using some interfaces. Indirect couplings or communication connections between apparatuses or units may be implemented in electrical, mechanical, or other forms.

The foregoing descriptions are merely specific implementations of embodiments of this application, but the protection scope of embodiments of this application is not limited thereto. Any variation or replacement readily figured out by a person skilled in the art within the technical scope disclosed in embodiments of this application shall fall within the protection scope of embodiments of this application. Therefore, the protection scope of embodiments of this application shall be subject to the protection scope of the claims.

What is claimed is:

1. A wireless communication method, wherein the method is applicable to a terminal device, and the method comprises:
receiving first indication information sent by a first transmission reception point (TRP) of a plurality of TRPs; wherein the first indication information is used to indicate or update at least one unified transmission configuration indication (TCI) state.

2. The method according to claim 1, wherein if a transmission mode of the plurality of TRPs is a transmission mode of multi-downlink control information multi-physical downlink shared channel (mDCI-mPDSCH), the at least one unified TCI state comprises at least one of following: a joint TCI state, a separate uplink TCI state, or a separate downlink TCI state, wherein the method further comprises:
determining a first CORESET resource pool to which a CORESET in which downlink control information (DCI) carrying the first indication information is located belongs, as a CORESET resource pool applicable to the at least one unified TCI state.

3. The method according to claim 2, wherein the method further comprises:
determining a TRP of the plurality of TRPs that corresponds to the CORESET resource pool applicable to the at least one unified TCI state, as a TRP applicable to the at least one unified TCI state.

4. The method according to claim 2, wherein the method further comprises:
determining that the at least one unified TCI state is a TCI state applicable to at least one of following:
a physical downlink control channel (PDCCH) on a CORESET in the first CORESET resource pool, a physical downlink shared channel (PDSCH) scheduled by DCI received on a CORESET in the first CORESET resource pool, or an aperiodic channel state information reference signal (AP-CSI-RS) triggered by DCI received on a CORESET in the first CORESET resource pool.

5. The method according to claim 1, wherein the method further comprises:
receiving second indication information sent by the first TRP; wherein the second indication information is used for activating or updating a unified TCI state for each of at least one code point.

6. The method according to claim 5, wherein the first indication information is used to indicate or update a first code point in the at least one code point.

7. The method according to claim 5, wherein the transmission mode of the plurality of TRPs is the transmission mode of multi-downlink control information multi-physical downlink shared channel (mDCI-mPDSCH), and the second indication information further comprises a CORESET resource pool to which a CORESET applicable to the at least one code point belongs.

8. The method according to claim 5, wherein the second indication information is used to activate or update at least one of following for each code point:
a plurality of joint TCI states;
at least one joint TCI state and at least one separate uplink TCI state;
at least one joint TCI state and at least one separate downlink TCI state; or
at least one separate uplink TCI state and at least one separate downlink TCI state.

9. The method according to claim 5, wherein the second indication information indicates one of following:
whether an i^{th} code point in the at least one code point comprises both a separate downlink (DL) TCI state and a separate uplink (UL) TCI state;
the i^{th} code point comprises or does not comprise a 2^{nd} joint TCI state;
the i^{th} code point comprises or does not comprise a 2^{nd} pair of separate TCI states; or
the i^{th} code point comprises or does not comprise an (X+1)^{th} separate TCI state, wherein X is an integer greater than 0.

10. A wireless communication method, wherein the method is applicable to a first transmission reception point (TRP) of a plurality of TRPs, and the method comprises:
sending first indication information to a terminal device; wherein the first indication information is used to indicate or update at least one unified transmission configuration indication (TCI) state.

11. The method according to claim 10, wherein if a transmission mode of the plurality of TRPs is a transmission mode of multi-downlink control information multi-physical downlink shared channel (mDCI-mPDSCH), the at least one unified TCI state comprises at least one of following: a joint TCI state, a separate uplink TCI state, or a separate downlink TCI state, wherein the method further comprises:
determining a first CORESET resource pool to which a CORESET in which downlink control information (DCI) carrying the first indication information is located belongs, as a CORESET resource pool applicable to the at least one unified TCI state.

12. The method according to claim 11, wherein the method further comprises:
determining a TRP of the plurality of TRPs that corresponds to the CORESET resource pool applicable to the at least one unified TCI state, as a TRP applicable to the at least one unified TCI state.

13. The method according to claim 11, wherein the method further comprises:
determining that the at least one unified TCI state is a TCI state applicable to at least one of following:
a physical downlink control channel (PDCCH) on a CORESET in the first CORESET resource pool, a physical downlink shared channel (PDSCH) scheduled by DCI received on a CORESET in the first CORESET resource pool, or an aperiodic channel state information reference signal (AP-CSI-RS) triggered by DCI received on a CORESET in the first CORESET resource pool.

14. The method according to claim 10, wherein the method further comprises:
sending second indication information to the terminal device; wherein the second indication information is used for activating or updating a unified TCI state for each of at least one code point.

15. The method according to claim 14, wherein the first indication information is used to indicate or update a first code point in the at least one code point.

16. The method according to claim 14, wherein the transmission mode of the plurality of TRPs is the transmission mode of multi-downlink control information multi-physical downlink shared channel (mDCI-mPDSCH), and the second indication information further comprises a CORESET resource pool to which a CORESET applicable to the at least one code point belongs.

17. The method according to claim 14, wherein the second indication information is used to activate or update at least one of following for each code point:
a plurality of joint TCI states;
at least one joint TCI state and at least one separate uplink TCI state;
at least one joint TCI state and at least one separate downlink TCI state; or
at least one separate uplink TCI state and at least one separate downlink TCI state.

18. The method according to claim 14, wherein the second indication information indicates one of following:
whether an i^{th} code point in the at least one code point comprises both a separate downlink (DL) TCI state and a separate uplink (UL) TCI state;
the i^{th} code point comprises or does not comprise a 2^{nd} joint TCI state;
the i^{th} code point comprises or does not comprise a 2^{nd} pair of separate TCI states; or
the i^{th} code point comprises or does not comprise an (X+1)^{th} separate TCI state, wherein X is an integer greater than 0.

19. A terminal device, comprising:
a processor and a memory, wherein the memory is configured to store a computer program, and the processor is configured to invoke and run the computer program stored in the memory to cause the terminal device to perform:
receiving first indication information sent by a first transmission reception point (TRP) of a plurality of TRPs; wherein the first indication information is used to indicate or update at least one unified transmission configuration indication (TCI) state.

20. A network device, comprising:
a processor and a memory, wherein the memory is configured to store a computer program, and the processor is configured to invoke and run the computer program stored in the memory to cause the network device to perform the method according to claim 10.
